(19) United States
(12) Patent Application Publication
(10) Pub. No.: US 2003/0009396 A1
(43) Pub. Date: Jan. 9, 2003

(54) Tracking and electronic signaling system

(76) Inventors: Raymond A. DeVries, Sumner, WA (US); D. Allen Fitz, Bothell, WA (US)

Correspondence Address: LAW OFFICE OF DAVID L. TINGEY, 321 BURNETT AVE. S., STE 303, RENTON, WA, 98055, US

(21) Appl. No.: 09/681,983

(22) Filed: Jul. 3, 2001

(51) Int. Cl. G06F 17/60

(52) U.S. Cl. 705/28

(57) ABSTRACT

A global supply chain solution database software package manages inventory levels and tracks internal shipment of parts and products between areas. It may automatically order or reorder inventory from suppliers and ship products to customers. Integrated inventory, tracking, transportation, automated ordering, receiving, sales, shipping, and contract software modules residing on several workstations through the manufacturing process are tied together for accuracy through a central server computer. Time flow analysis and management reporting is provided at every step of the process in standard and custom formats. A secure Internet inventory interface provides visibility from the manufacturer, who may transfer responsibility for controlling its inventory and for providing “just in time”delivery to the supplier. Either the manufacturer or the supplier may control inventory.

### BACKGROUND OF INVENTION

The traditional manufacturing process includes: Procuring the raw materials and parts (inventory) from suppliers, maintaining the inventory on hand, manufacturing a product, and delivering finished goods to customers in a timely manner.

Historically, the manufacturer was responsible for ensuring adequate inventory was on hand and available to meet its production needs. Forecasting future production was based upon “best estimates”. Inventory parts were usually ordered quarterly, and large quantities were stored on hand to protect the manufacturer against shortages, manufacturing slowdowns, and lost revenue resulting from unexpected, increased demand for its product. Furthermore, procuring and maintaining inventory was labor intensive. Purchase orders, trucking and shipping manifests, tracking tags, documentation of receipt, invoices, payments, etc. were all hand generated and subject to human error.

Manufacturing the finished product was also disjointed. Production delays occurred as parts ordered from inventory were lost in transit to the work site, or as finished products were routed for shipment and delivery to customers. And like inventory control, these were manual processes.

Cost effective automated systems were not readily available as alternatives to established manual control methods until recently. Automation has gradually replaced many of the tasks in the manual process as computerization has become more affordable. With it, a new term has been coined to describe this manufacturing process. It is now commonly referred to as Supply Chain Management.

As computers and Internet technology have become more affordable, companies have begun to install systems designed to streamline a particular task. Those in current use include, but are not limited to individual inventory, tracking, transportation, order and receiving systems. They may have either been designed in house or purchased from a software manufacturer. Unfortunately, each one is unique, stands-alone and is not integrated with other in house systems. These systems remain labor intensive, because data typically cannot be shared between them, and employees must manually reenter data into more than one system. This, in turn, opens the door to erroneous and inaccurate data. Employees must continue to verify orders, shipments, freight location, payment status, etc., often by telephone without success.

In addition, these nonintegrated systems cannot be used as management tools to accurately forecast future business or to control inventory levels. The manufacturer remains responsible for its inventory.

Instead of basing inventory (re)orders on current inventory levels and usage, orders are generated from projected sales. They are not using a lean “pull system”that generates requirements from the end user, and shortages occur for parts that have high rejection rates or flexibility in usage that are difficult to forecast. There is no history at the fingertips of the procurement agent to assist with just-in-time (systematic) ordering or strategic planning.

### SUMMARY OF INVENTION

The overall objective of the Tracking and Electronic Signaling System (TESS) is to combine the total supply chain management process into one integrated inventory and tracking package. More specific objects include enabling a manufacturer to: [symbol] Monitor inventory levels and reorder when needed, instead of at predetermined times.

[symbol] Minimize inventory warehousing.

[symbol] Share inventory data with its suppliers via a secure Internet based interface.

[symbol] Transfer responsibility for tracking and replenishing part inventory to suppliers.

[symbol] Track in-house location and internal shipment of parts, product components and finished products between plant sites and facilities.

[symbol] Utilize a comprehensive management reporting system to monitor its entire supply chain management process.

[symbol] Accomplish this via a one-time data input, portable reader interface and on-line control that is tied together by the TESS generated unique tracking identification code, (Tracking ID).

[symbol] Perform functions using a single bar code scan.

[symbol] Use a portable bar code reader interface.

[symbol] Generate corresponding bar coded Tracking Tags for on-site tracking.

Further objects include enabling a manufacturer's supplier to: [symbol] Access and view the goods it provided the manufacturer without permitting it access or to view other suppliers' data.

[symbol] Replenish and maintain the manufacturer's inventory at just-in-time intervals.

A further object is to allow trading partners to share accurate and timely data via an Internet interface. A further object is to permit suppliers visible access to inventories of their own products on the user's site, but not those of other suppliers. This protects suppliers that have common or competitive or proprietary information from viewing each other's information with the same customer.

These objects are achieved by visibly tracking flow of parts and products through the manufacturing process with computerized and automated inventory credits and debits. Integrated inventory, tracking, transportation, automated ordering, receiving, sales, shipping, and contract software modules residing on several workstations through the manufacturing process are tied together for accuracy. Time flow analysis and management reporting is provided at every step of the process in standard and custom formats.

A secure Internet inventory interface provides visibility from the manufacture, who may transfer responsibility for controlling its inventory and for providing “just in time”delivery to the supplier. Either the manufacturer or the supplier may control inventory. At the same time, availability and production requirements are provided that allow for inventory reduction by both the manufacturer and supplier.

TESS can be used as a “stand alone system,”or it can be integrated with internal applications already in place and serve as a “check and balance”system.

### BRIEF DESCRIPTION OF DRAWINGS

FIG. 1 shows the TESS modules connectivity chart.

FIG. 2A-C show the Workstation Module flow.

FIG. 3 shows the Tracking Module flow.

FIG. 4 depicts how the TESS Tracking Tag is formatted with both “To”and “From”addresses, plus the bar coded Tracking ID.

FIG. 5A 5I show the Inventory Module flow.

FIG. 6 shows the Order Module flow.

FIG. 7 shows the Contracts Module flow.

FIG. 8 shows the Receiving Module flow.

FIG. 9 shows the Sales Module flow.

FIG. 10 shows the Shipping Module flow.

FIG. 11 is an example of an American National Standards Institute MH10 Shipping Label that the Shipping module produces.

FIG. 12 shows the Invoice Module flow.

FIG. 13A-C show the Supplier Module flow.

FIG. 14 shows Supplier Module connectivity.

FIG. 15 shows the Transportation Module flow.

FIG. 16 shows the Reusable Container Module flow.

FIG. 17 is a sample reusable container label.

FIG. 18 shows the Hazardous Material Module flow.

FIG. 19 shows an operational system process flow.

FIG. 20 represents selected modules loaded at indicated workstation types FIG. 21A-B show the System Administrator Module commands and process flow.

FIG. 22 is a table showing selected linkage between modules and tables.

### DETAILED DESCRIPTION

The Tracking & Electronic Signaling System (TESS) is a global supply chain solution software package. It manages manufacturer inventory levels and it tracks internal shipment of parts and products between work areas and/or facilities. TESS data may be used for comprehensive management reporting. It may automatically order or reorder inventory from suppliers and ship products to customers, without compromising security between its trading partners.

TESS is designed as a set of at least fourteen modules. Each one performs a particular TESS function that interfaces with one or more other modules, using the TESS generated unique Tracking Identification Code, referred to as the Tracking ID. A manufacturer may choose not to install all TESS functions in its facilities. However, the System Administrator Module 10, the Workstation Module 12, the Tracking Module 14 and the Inventory Module 16 are the engines that generate the Tracking ID and drive the remaining modules. These four modules (TESS Basic) comprise the minimum TESS installation.

The TESS interface between modules is a table and in some cases also a function. When viewing the Module flow charts, reference is made to customer and supplier. When TESS acts like a manufacturer, it supplies finished goods to its customers. In this case, the manufacturer is a supplier. For manufactures or suppliers who are responsible for inventory and uses TESS to monitor inventory, the manufacturer receiving the parts is the customer, and the one supplying the parts is the supplier.

The figures illustrating program flow show both Commands and Functions. Commands are command buttons provided on the main screen of each Module. Functions are a program code that is executed in response to a command button or event.

TESS Basic functions are limited to tracking inventory on hand and its in-house transit within and between a manufacturer's facilities. The TESS Basic modules, together with six additional modulesthe Order Module18, the Invoice Module 20, the Receiving Module 22, the Contracts Module 24, the Sales Module 26 and the Shipping Module 28 permit the TESS user to also track orders and receipt of inventory from its suppliers, track sales and expedite shipment of its products to customers, and track whether or not these deliveries/shipments are processed and paid as stipulated by contract. This expanded ten-module system is referred to as TESS Plus.

An eleventh module, the Supplier Module 30, together with TESS Plus, provides an Internet interface 32 that enables a TESS Plus user to connect with suppliers who are also TESS users. This added feature permits a manufacturer's supplier to access its inventory, without permitting the supplier to access the data of other suppliers, protecting restricted data in tables behind a software firewall. The TESS manufacturer may transfer responsibility for its inventory to the supplier, which in turn may reduce the amount of inventory and warehouse space the manufacturer must maintain. This enhanced eleven-module package is referred to as TESS Supplier.

The other modules are available as options for all TESS users. They are the Transportation Module 34, the Returnable Container Module 36, the Hazardous Material Module 38, and the Banking Module 40. The Transportation Module 34 assists manufacturers having a separate transportation entity within its organization responsible for transporting its internal shipments. The Reusable Container Module 36 and Hazardous Material Module 38 are used to generate unique labeling and tracking tags required when using these containers, respectively. A TESS Basic, TESS Plus or TESS Supplier user may include any one or all of these optional modules for its system.

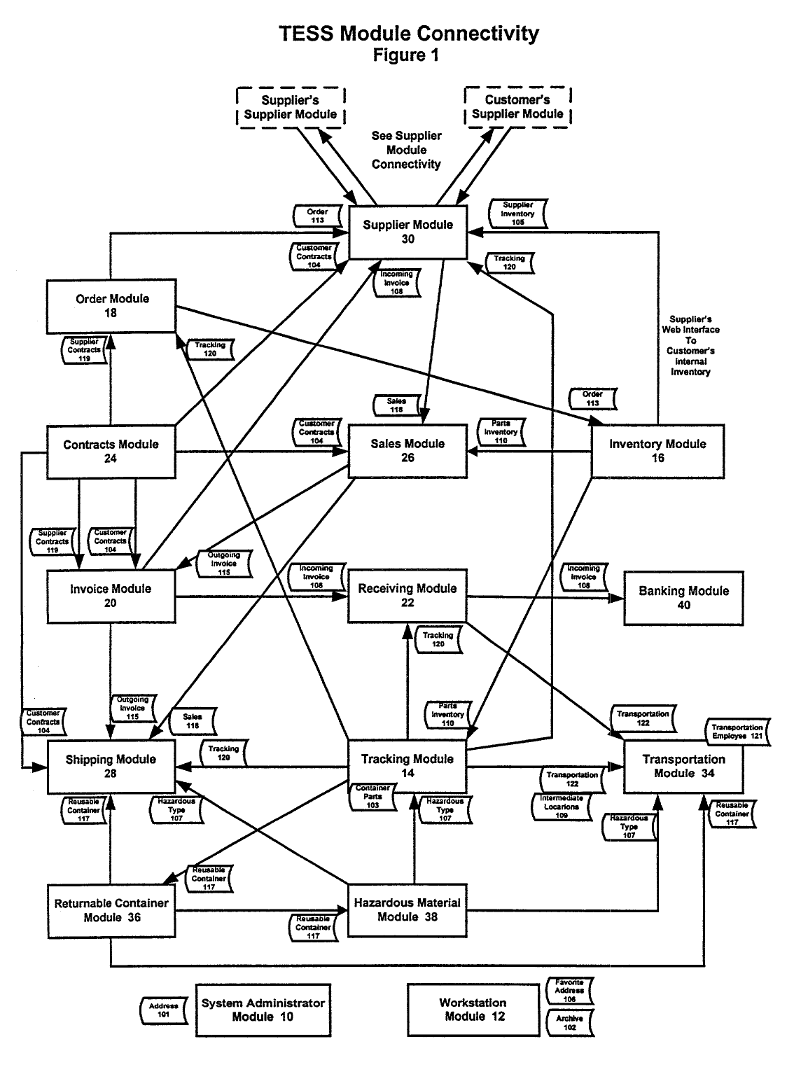

FIG. 1 shows the TESS modules connectivity chart, defining how the TESS modules are related and the table used for their interface. An arrow indicates direction of program flow. The connectivity chart shows the System Administrator 10 and Workstation modules 12 as not interfacing with other modules only for simplicity of illustration.

TESS input and interfacing is done at a TESS workstation 36, which is a personal computer (PC). A manufacturer's physical area such as a receiving area may have multiple workstations and each identified to TESS as “Receiving”. TESS files, unique to a particular workstation, are loaded and stored on individual workstation PC hard drives in order to add security and relieve storage capacity on a shared server, or central computer.

For ease of description, the following definitions are useful: Definitions Tables and Terms:

AddressID2( ) A variable used by the TESS system to define the Address Name of the Workstation

Address Name The name of the Workstation that identifies its logical location, such as RECEIVING, PART STORE 1, etc.

Address Table A table containing the names and physical locations of all workstations using TESS. This table contains the Address Name of the workstation, Workstation Type, Inventory Flag, Physical Location, data flags, and related Transportation Organization.

Archive Table A table containing archived data in the same format as the Tracking Table.

Configuration File A file that contains information controlling the setup and configuration of the Workstation.

Container Label Table A table that contains information required for printing container labels. This table keeps track of which labels have been printed so duplicates are not made.

Container Parts Table A table that contains the part numbers that are in the container identified in the Tracking Table, Tracking ID (to link to the Tracking table), serial numbers, lot number, order numbers, quantity, and unit price data.

Customer Contracts Table A table that contains all the parameters for purchases of parts by a customer from the manufacturer. It contains the Supplier ID, part number, unit price, ship quantity, shipping method, payment schedule, and contract data. The corresponding table for the Supplier is the Supplier Contracts Table.

Favorite Address Table A subset of the Address Table containing the Address Names most frequently used by a given workstation.

From Address The Workstation Name of the workstation sending a container.

Hazardous Material Code A code that defines the material type for the labeling and documentation required.

Hazardous Type Table A table that contains the hazardous material code and the related text for the hazardous material label and documentation.

Incoming Invoice Table A table that contains the invoice information for parts being purchased from a supplier. This table is used by the Banking Module to generate payments.

Intermediate Location A location that is not the From Address or the To Address at which a container stops during the process of tracking a container.

Intermediate Locations Table A table containing the locations where a Tracking Tag has stopped during the process of moving it from the From Address to the To Address. The Tracking ID links entries in this table to the Tracking Table.

Inventory Flag A flag that identifies if a Workstation will have inventory or not.

Inventory Parts Table A table that is linked to the Inventory Table and contains information about specific parts in the inventory. It contains the Part Number, Serial Number, Lot Number, Bin Location, and Quantity at the Bin.

Inventory Request Table A table containing all Inventory Requests. It contains the requesting Address Name, the To Address Name, Part Number, Quantity, Accept/Reject indicator and date.

Inventory Table A table containing the inventory for all workstations. This table contains the Address Name of the owner of the part, Supplier ID, Part Number, Total Quantity, Minimum and Maximum Balance Quantities, Reorder Quantity, Inventory Responsibility Flags, Responsibility Flag, and other indicators. Note: bin locations are stored in the Inventory Parts Table.

Invoice table A table that contains the invoice data for a sale or order. It contains Supplier number, customer number, part number, description, quantity, unit price, total price, and payment terms.

Inventory Transfer The process of transferring parts from one workstation's inventory to another workstation's inventory.

Linkage Table A table used by the Supplier Module to link to a customer's Supplier Inventory (inventory monitored by a Supplier). The inventory will be on a server belonging to the customer and outside its firewall. The Linkage Table provides the path to this server.

Order Table A table that contains all orders placed by the company from the Inventory Module or Supplier Module. The order table also includes a supplier number, the workstation that ordered the part, part number, quantity, unit price, shipping instructions, and buyer data.

Outgoing Invoice Table A table that contains the Invoice information for parts being sent to a customer. The Invoice and Packing slip are made from this table for shipments.

Part or Part Number—refers to all items, components, raw materials, etc. having a particular part number or description that is tracked in TESS using the Tracking ID.

Response Table A table located on the external server that serves to pass information between a supplier and a manufacturer. It contains customer and supplier numbers, Tracking ID, and part number data. This is the same server that the Supplier Inventory is stored on.

Reusable Container Table A table that contains all reusable containers. It contains the container type, sequence number, owner and current location.

Sales Table A table that contains all sales made to customers. It contains the Customer ID (DUNS number), purchase order, part number, quantity, and other related data.

Shop Parts Issue Table A table that contains the records of parts issued to a shop and the part number, quantity, work order, shop number, and unit price.

Supplier ID The DUNS number assigned to a supplier.

Shipping Label A label that is placed on the package or container containing the From and To street address of the Supplier and Customer. This label when generated by TESS will comply with ANSI standards.

Supplier Contracts Table A table that contains all the parameters for the purchases of parts by the Manufacture from the Supplier. The related table is the Customer Contracts Table.

Supplier Inventory Table A table containing the inventory of parts for which a Supplier is responsible. This table(s) is located on a server outside the companies firewall and accessible by suppliers. It contains the Address Name of the owner of the part, Supplier ID, Part Number, Total Quantity, Minimum and Maximum Balance Quantities, Reorder Quantity, Responsibility Flag, and other indicators.

Supplier Inventory Table A table containing the inventory of parts that for which a supplier is responsible. This table is located on a server outside the company's firewall and is accessible by suppliers. It contains the Address Name of the owner of the part, Supplier ID, Part Number, Total Quantity, Minimum and Maximum Balance Quantities, Reorder Quantity, Responsibility Flag, and other indicators.

Tracking Tag A label generated by the Tracking module which has the Manufacture's internal address for the From Address and To Address. The Tracking ID is bar coded on this label to allow input by bar code readers.

Tracking ID A unique number automatically assigned by TESS to Tracking Tags and its entry in the Tracking Table. It is used by other Modules to link to the data contained in the Tracking Table. The Tracking ID is what is bar coded on the Tracking Tag and the Shipping Tag along with the DUNS number.

Tracking Table A table that contains the information included on a Tracking Tag. Its index is the Tracking ID, which is used through out TESS to link tables and processes. This table contains the Tracking ID, Container Number, Workstation From Address, Workstation To Address, Date Sent and Date Closed.

Transportation Employee Table A table containing the names of employees assigned to the Transportation Department who are responsible for moving containers. Names are selected from this table and placed into the Transportation Table as the person assigned to the move.

Transportation Table A table that contains the transportation requests sent to the Transportation Module. It contains the Address Name of the Transportation Workstation assigned to the move, the From and To Address Names, Tracking ID, and person assigned.

To Address The Workstation Name to which a container is being sent.

Workstation Both a logical and physical area where a TESS PC exists.

Workstation Name A logical name (Address Name) of the Workstation.

Workstation Type A code that defines which Modules the Workstation will have access to.

As stated previously, TESS generates the unique Tracking ID. TESS uses it to track: Movement of parts within a manufacturing facility.

Individual work area inventories.

Transportation department activity.

Reusable and hazardous waste containers.

Parts transfer and inventory picking.

Ordering, shipping and receiving functions.

Common information for communicating between the Supplier and the Manufacture. Also used when communicating between the Manufacture and the Customer.

TESS Basic:The System Administrator Module 10 is used to configure TESS and how the workstations are used in the manufacturing facility. Its access is limited to individuals designated by the manufacturer as TESS System Administrators.

The interface between the System Administrator Module and TESS is a configuration file set up to pass the setup parameters to TESS. This configuration file contains the Address Name of the Workstation, Label Printer used, Portable Reader Port and parameters input during TESS logon.

The commands provided by the System Administrator Module 10 are:

Change Workstation Name The command to Change Workstation Name, when selected opens the Change Workstation Name screen. The user selects a new Address Name. The command then stores this in the Workstations configuration file and changes the public variable AddressID2( ) to the new address Name. This becomes the default Workstation Name next time the user logs onto TESS.

Update Address Table The command to Update Address Table, when selected, opens the Update Address Table screen and displays all entries in the Address Table. The user may edit all fields for all entries in the Table. The Address Table contains the Workstation Names, physical location, type of Workstation (Normal, Transportation, etc.), Inventory Flag, and Transportation information for the Transportation department routing.

Display Users Logged On The command to Display Users Logged On, when selected, opens the Users logged on screen which displays all Workstations currently logged onto TESS.

Portable Reader Port Setup The command, Potable Reader Port Setup, when selected, executes the function PortableSetup( ). This function prompts the user for the PC serial port that the portable reader is attached to, and stores this in the Workstations configuration file.

Install Label Printer The command Install Label Printer, when selected, executes the function New Printer( ). This function prompts the user for the printer type, stores this in the Workstation's configuration file and stores this into the public variable PrinterType( ).

Setup Archive Days The command Setup Archive Days, when selected, executes the function Archive Setup( ). This functions prompts the user for the number of days after the Tag is closed before data is to be archived, the number of days from close that the Tag is to be deleted from the archive table, and stores these variable in the Workstations configuration file.

The system administrator sets up the following parameters for each workstation, and only a system administrator may modify these parameters.

Company Name.

Company Dun and Bradstreet number (DUNS number).

Address ID (Workstation Address Name) and Address Name changes.

Serial port that the portable readers will use to input data.

Type of Label printer used (Zebra model number).

Archive parametersthe number of days before data is archived, and the number of days before data is deleted from the archive table.

Workstation Address Table used by TESS—includes the workstation type, inventory indicator, physical location.

Transportation Name—name of the Transportation Dispatch area, ID designated, for the workstation.

Tracking Tag Priority and Status tables.

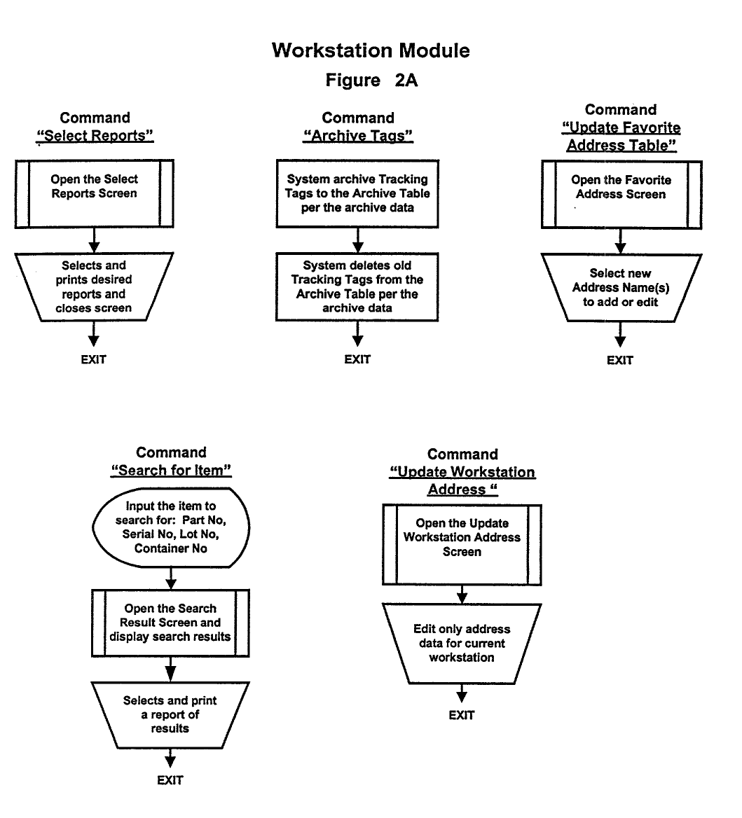

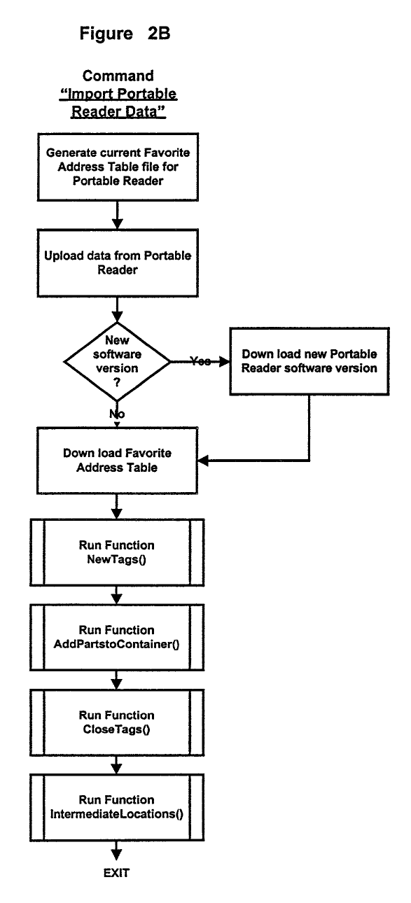

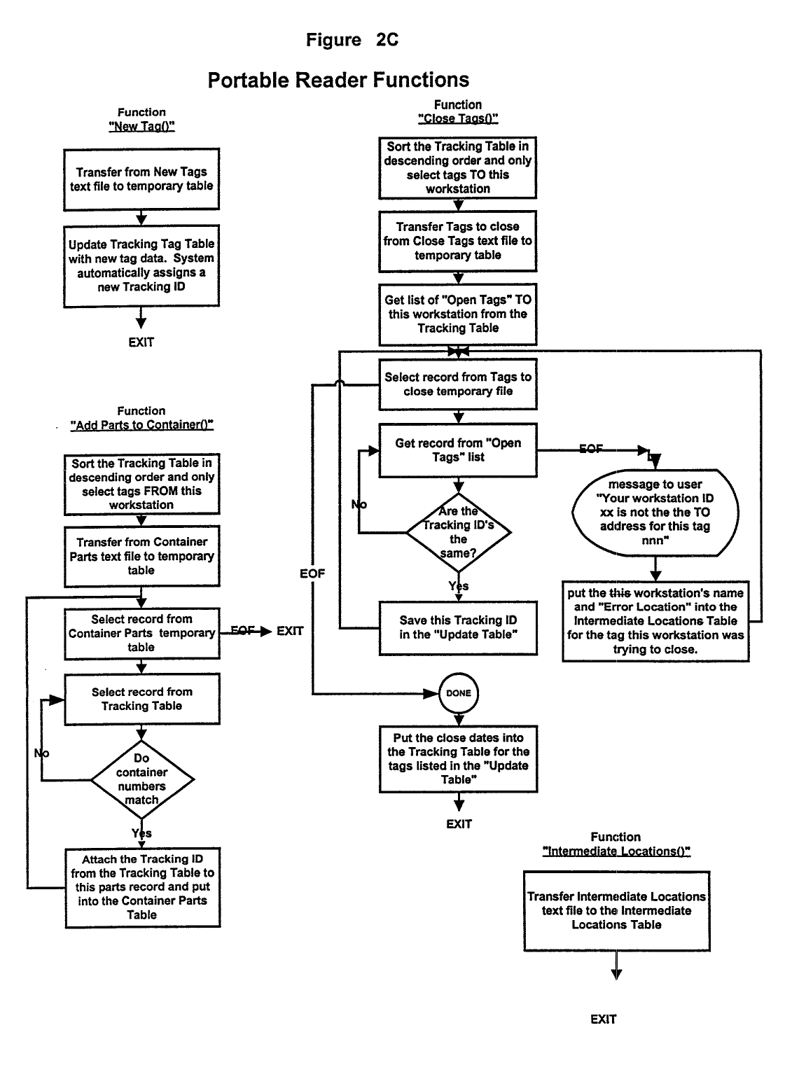

Display users logged onto TESS Workstation Typeidentifies workstation functions by designating which TESS modules may be accessed at each TESS workstation (charted below). This streamlines the number of functions for each workstation and makes the system more “user friendly.”FIG. 2 shows the Workstation Module flow. The Workstation Module 12, the second of the four TESS Basic modules, interfaces with the other modules and enables any workstation user to input or access functions common to all TESS users. These common functions include:

Update Workstation Address information, but not the Address Name.

Update a Favorite Address Table, a subset of the Address Table of all Address Names controlled by the system administrator. A workstation typically has a few workstation addresses that it uses, and lists them in its table. This feature allows a user to change “favorite”addresses as needed.

Archive closed Tracking Tags.

Search for parts in TESS by “Container Type”, Part Number”, Order Reference”, “Serial Number”and “Lot Number”, which are variables entered when preparing a Tracking Tag. This feature enables any TESS user to search TESS for location part in transit.

Import portable reader data.

Display and print TESS shipment status and time flow reports.

The Workstation Module 12 provides the general functions that do not fit into any other Module. It does not provide any interface to or between the other Modules. It does however provide setup of some tables that are for the most part stagnant, but do provide data to other Modules.

The commands provided by the Workstation Module are:

Select Reports—The command to Select Reports, when selected, opens the Reports Screen displaying the options for reports.

Archive Tags—The command to Archive Tags, when selected, will query the Tracking Table for tags that fit the archive parameters (defined in the System Administrator Module) and move them from the Tracking Table to the Archive Table. It then deletes old tags that fit the criteria for deleting from the Archive Table.

Update Favorite Address Table—The command to Update Favorite Address Table, when selected, loads the screen displaying the current favorite address table for this Workstation. The user may then add or edit the table.

Search for Item—The command to Search for Item, when selected, displays a small screen that the user must input the item to search for. TESS then queries the Tracking Table for that Item and displays all occurrences. The user may then print a report of the Item.

Update Workstation Address—The command Update Workstation Address, when selected, opens the Workstation's Address screen and allows the user to edit data for their Workstation only.

Import Portable Reader Data—The Command to import portable reader data executes an event which builds the current Favorite Address Table for the portable reader, Uploads data from the portable into text files on the Workstation, checks to see if a new version of software exists for the portable and down loads it, down loads the Favorite Address Table into the portable, then executes the functions to process the data. The functions are:

New Tag which creates a new Tracking Tag entry into the Tracking Table.

Add Parts to Containers, which adds the parts to the Container Parts Table that are associated with the above Tracking Tag.

Close Tags, which closes Tracking Tags which have arrived at the Workstation by putting the date into the “Date Closed” field of the Tracking Tags entry in the Tracking Table.

Intermediate Locations, which adds an entry into the Intermediate Locations Table and links it to the Tracking Tag's Tracking ID.

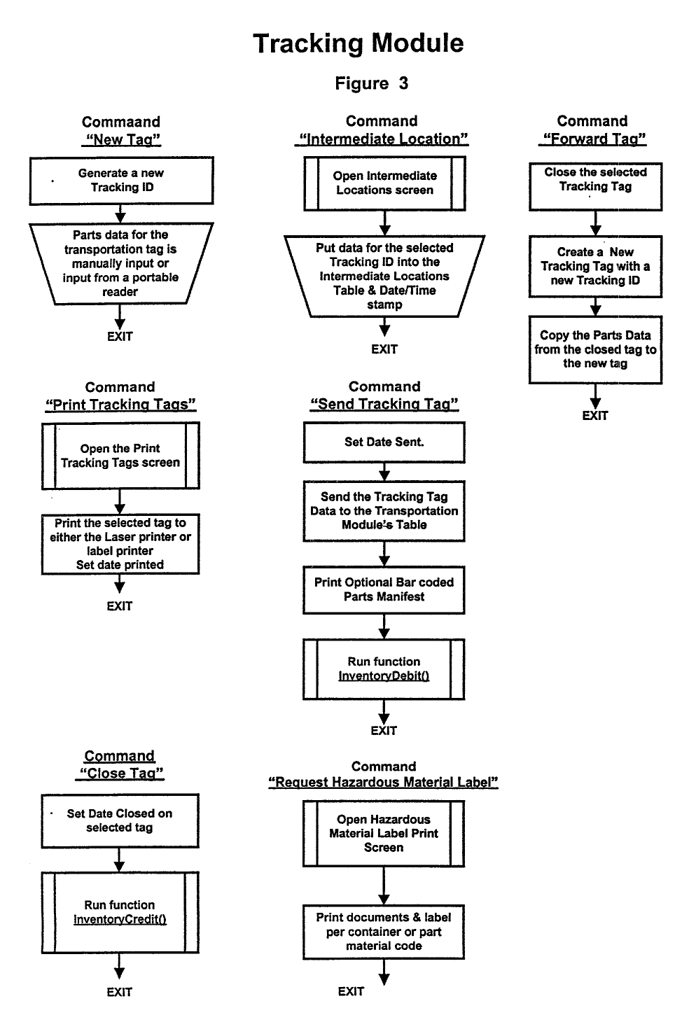

FIG. 3 shows the Tracking Module flow. The Tracking Module 14, the third and primary TESS Basic module, generates and assigns the unique tracking identification code used to track all TESS parts. As stated previously, this unique code is also referred to as the Tracking ID. The Tracking Module, used to track the internal movement of containers and parts within a company, generates a new TESS shipment, adds additional parts to an open shipment, tracks intermediate shipment locations, and to close TESS shipments. The Tracking Module maintains the Tracking Table, Container Parts Table and Intermediate Locations Table.

The Tracking ID is assigned with the “New Tag”command, selected at the workstation. Data entries required in order to generate the Tracking Tag, bar coded with the Tracking ID and used to track the shipment, include the “Container Type” (see Container Labels described in Reusable Container Module above). Also needed are the “Part Number”, the “Quantity”, the “Number of Boxes”(selected from the Container Parts Table).and the “To Location” (selected from the Favorite Address Table described in the Workstation Module).

Once the container is ready for shipment, the bar coded Tracking Tag is printed and attached to the container. TESS automatically records the date sent in the Tracking Table, Prints a Manifest, and starts the clock for tracking the shipment. Intermediate Locations data for active TESS shipments is input through a workstation at the stop or transfer point by intermediate Location Commanding.

TESS automatically stops the clock and closes the Tracking Tag when a TESS user selects “Close Tag”command. The date closed is stored in the Tracking Table. TESS offers a “Forward Tag”command, to allow a user to send a container to another Workstation (To Address) without having to physically re-enter any data. This is useful when a container arrives at the To Address Workstation and they wants to send the entire container or most of it to another workstation.

TESS Basic Tracking Module shipments and the bar coded Tracking Tags may also be tracked and scanned using portable barcode readers in lieu of PCs. Because these readers can scan the bar code, it is not necessary to input data into a PC, which may be less cumbersome and more efficient.

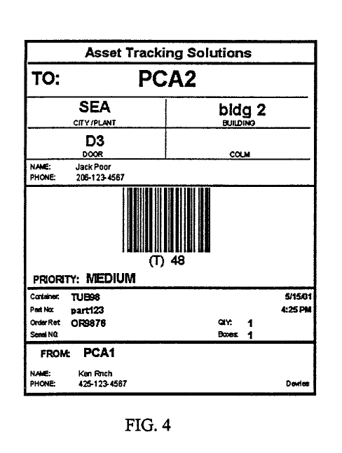

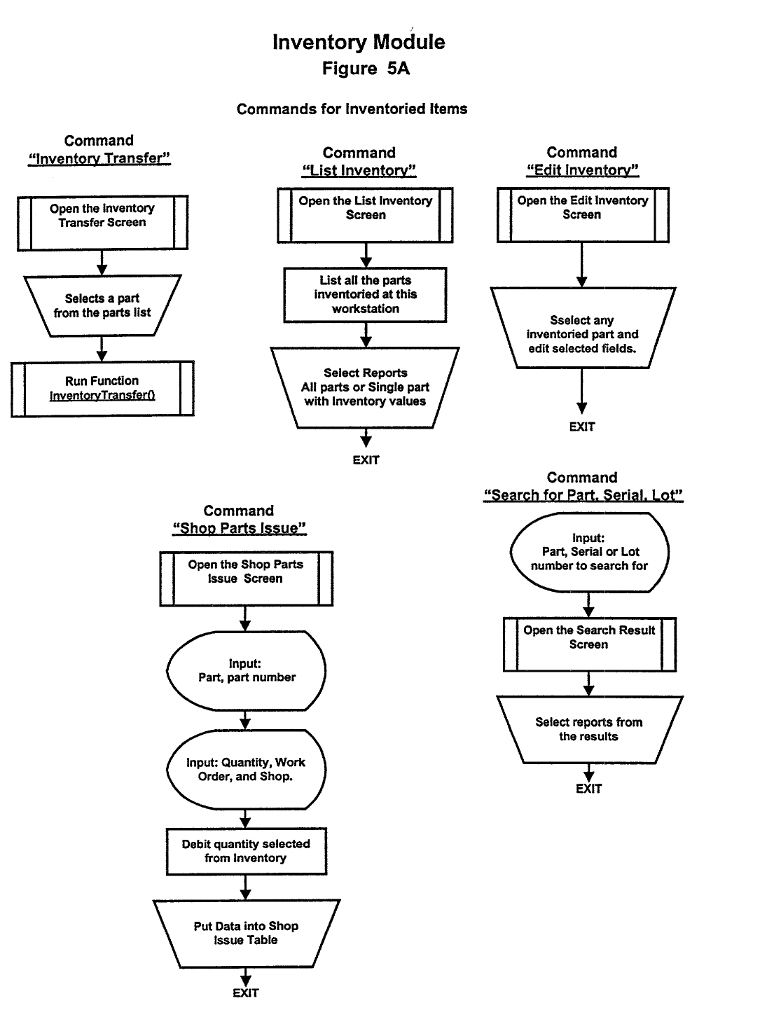

FIG. 4 depicts how the TESS Tracking Tag is formatted with both “To”and “From”addresses, plus the bar coded Tracking ID. The name of the manufacturer is printed on the top line.

The commands provided by the Tracking Module 14 are:

New Tag The command New Tag, when selected, generates a new Tracking ID number and displays it on the Tracking screen. The user must provide the container number, parts list, and To Address Name (from the Favorite Address Table).

Intermediate Location The command Intermediate Locations, when selected, opens the Intermediate Locations screen, links it to the desired Transportation Tag and displays all Intermediate Locations for that Tracking Tag. For a new Intermediate Location entry, the user inputs a name (theirs) and location. TESS then date and time stamps the transaction and stores it in the Intermediate Locations Table.

Forward Tag Forward Tag is the process of forwarding a container that has arrived at the To Address location, to a new Address Name when the container and parts do not change. The command Forward Tag, when selected, puts the system date into the Date Closed field of the selected Tracking Tag, and generates an identical Tracking Tag (same parts list) with a new Tracking ID. The From Address is the Workstation generating the new Tracking Tag. The user must input the new To Address from the Favorite Address Table.

Print Tracking Tags The command Print Tracking Tags, when selected, opens the Print Tracking Tags screen. The user selects the Tracking Tags to print and output device.

Send Tracking Tag This command Send Tracking Tag, when selected, sets the Date Sent field to the system date and time, sends the Tracking Tag data to the Transportation Module's Transportation Table, gives the user the option to print the bar coded parts manifest and debits the inventory of the From Address (if it has inventory). See Inventory module for Inventory Debit function.

Close Tag The command Close Tag, when selected, puts the system date and time into the Date Closed field of the selected Tracking Tag, and credits the inventory of the To Address (if it has inventory). See Inventory module for Inventory Credit function.

Request Hazardous Material Label The command Request Hazardous Material Label, when selected, opens the Hazardous Material Label Print screen. The user inputs the hazardous material code, and the documentation and/or label are printed.

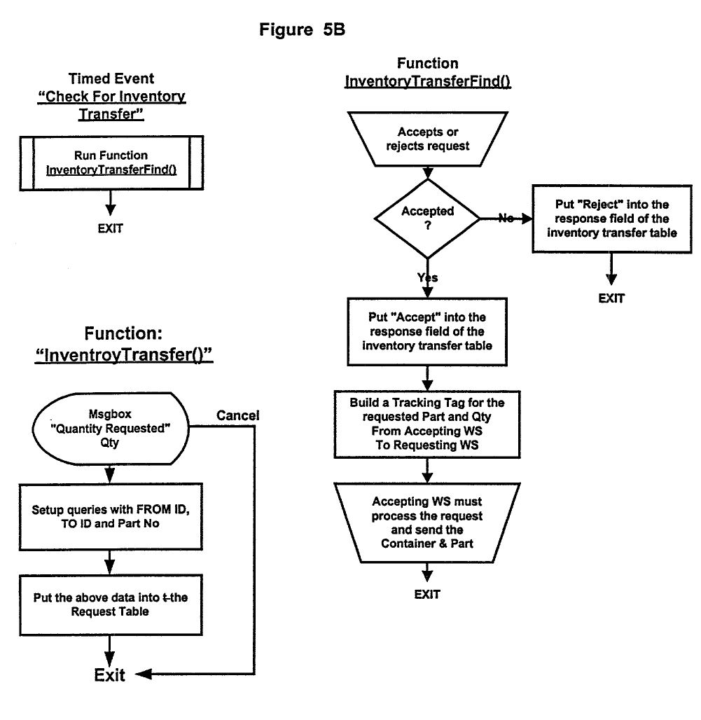

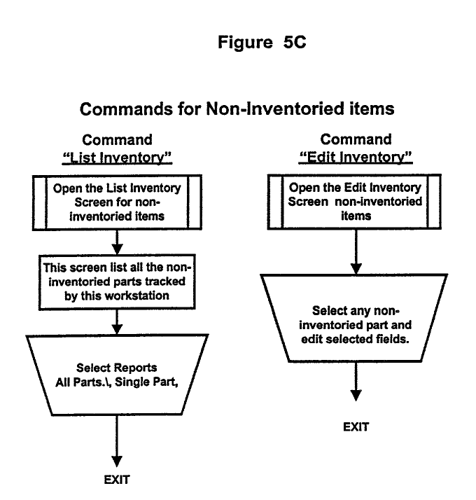

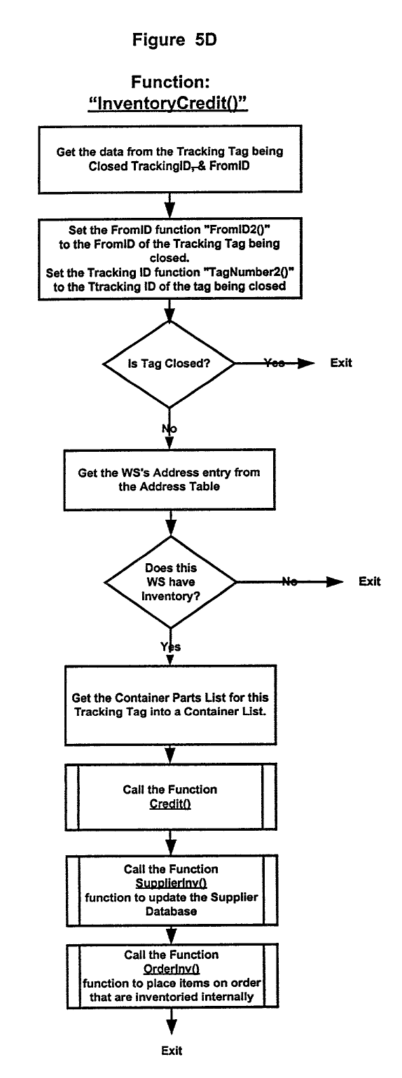

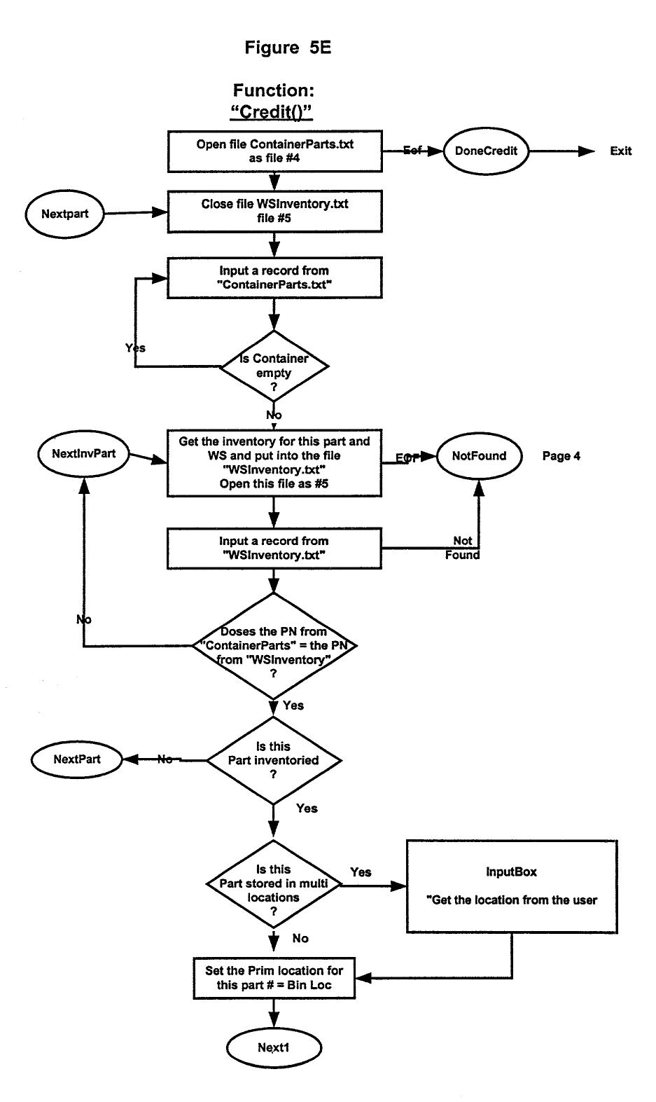

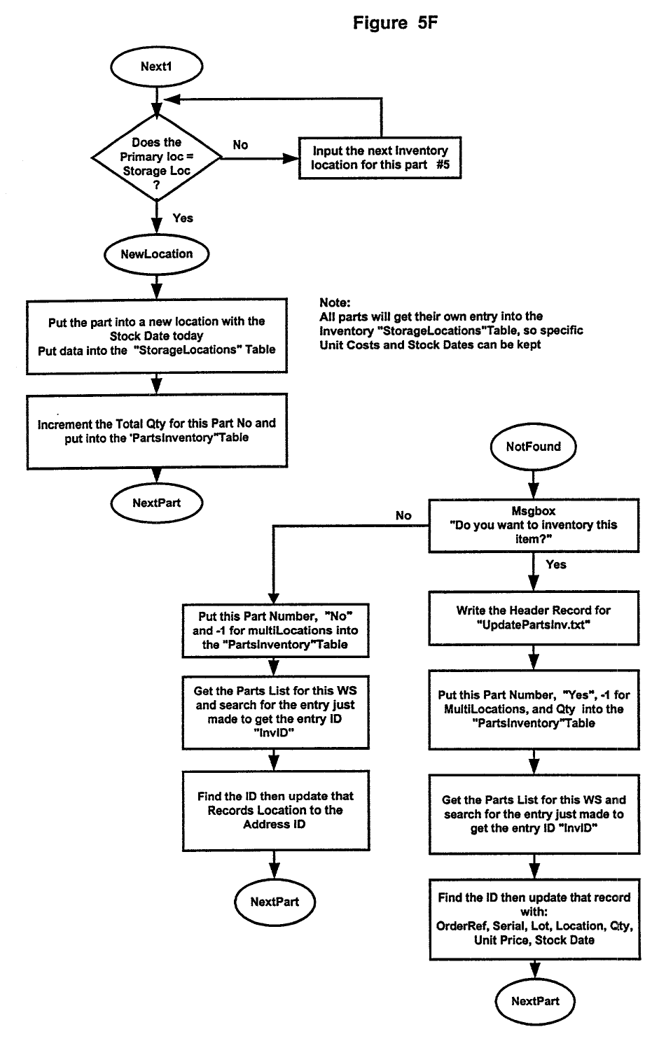

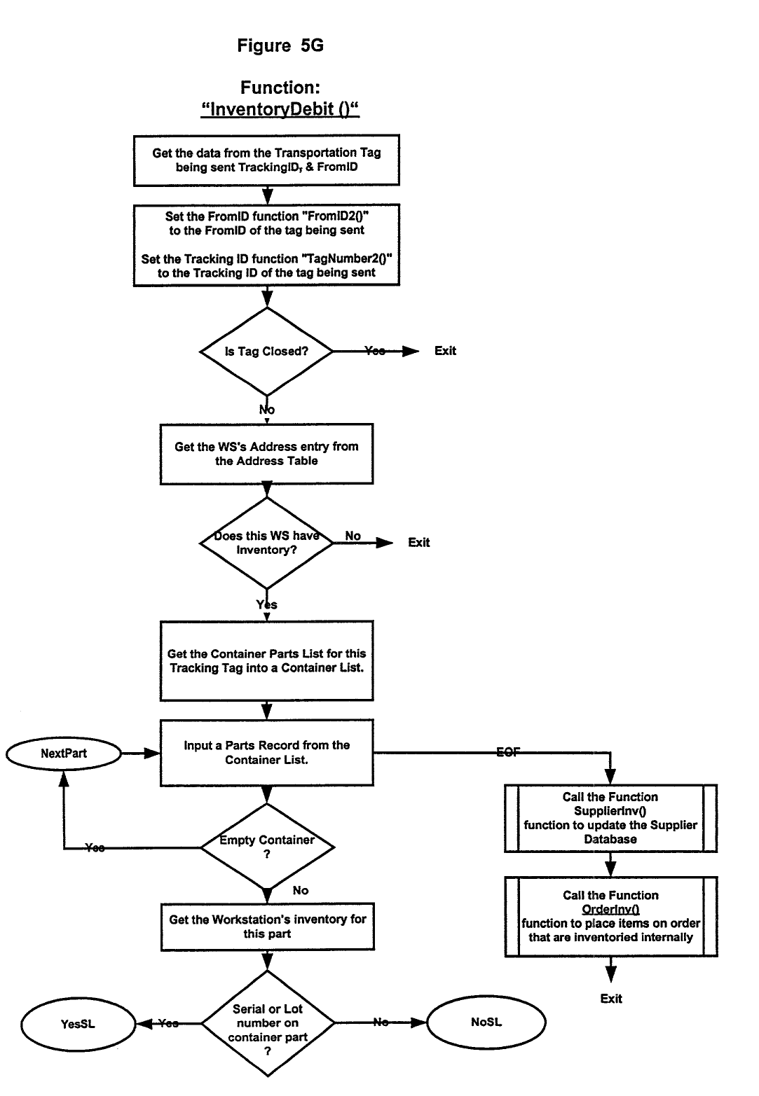

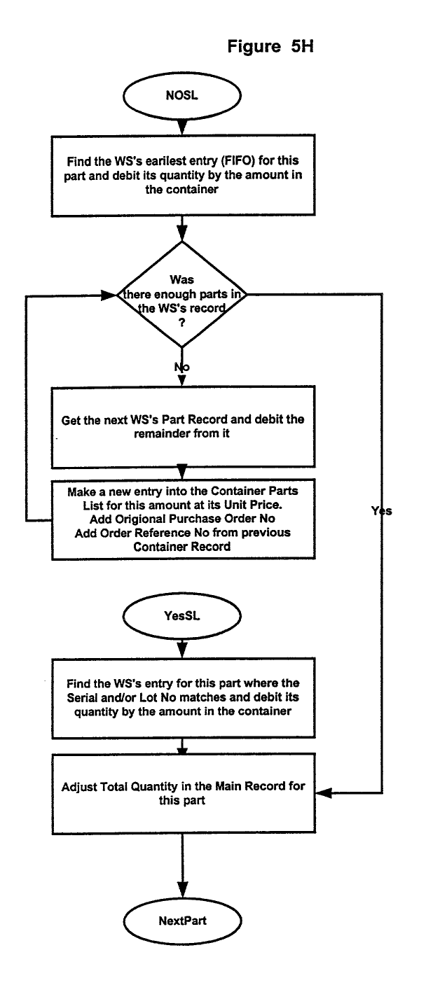

FIG. 5 shows the Inventory Module flow. A manufacturer uses the Inventory Module 16, the fourth and last TESS Basic module, to track the inventory of workstations having inventory and to control inventory location and quantity(s) on hand throughout the facility(s). An Inventory Flag is provided in the Address Table to indicate if a workstation has inventory. If it is set to “No”, then this module and related modules are not available for the user.

The Inventory Module 16 categorizes all parts as either “Tracked”or “Not Tracked”. The “Tracked”parts are stored as workstation active inventory by category(s) including, but not limited to part number, lot number, quantity, location, stock date, and/or unit price. Parts “Not Tracked”, such as paper towels and similar non-reusable supplies, are categorized by Part Number only. Two forms are provided to manually enter parts into either inventory. When a Tracking Tag is closed, TESS will perform an inventory credit of the parts attached to the Tracking Tag. If a part number does not exist, the user will be asked if they want to track the part number. If the TESS user opts this first time to not Track (“No”) a part when it is received at the workstation, the part is flagged as “Not Tracked”. The second time this part number arrives at the same workstation, it is ignored. Users choosing to include the part in inventory, adds it by selecting “Yes”to the prompt. The user will also be asked for the storage location. The user may edit either the active or non-inventoried part numbers.

The Inventory Module 16 contains 2 tables. The first, Inventory Table, contains all part that passes through a Workstation having inventory. It contains the part number, inventory flag, total quantity, and all other flags to indicate how the part is used and inventories. The inventory flag is used to determine if the part is inventoried or not. If the part is inventoried, then entries are made into the second table. The second, Inventory Parts Table, contains the part number that links it to the first table. This table may contain multiple entries of the same part number. Each time a part is credited to the inventory, a new entry is created with the stock date, bin location, quantity and unit price.

The Inventory Module 16 and Tracking Module 14 directly interface with each other when sending TESS shipments. Users initiating TESS shipments at workstations with inventory on hand, select the “Pick From Inventory”command on “New/Edit Outgoing TAGS”. TESS uses the Inventory Module “Pick From Inventory” form[**], to select which parts to add to the shipment and to transfer the corresponding part data to the outgoing Tracking Tag. The Inventory Module 16 then automatically debits this Tracking Tag part data from the “From Location” inventory as the TESS user selects the “Send Tag and Print Manifest”command to send the shipment. The Inventory Module then automatically credits all Tracking Tag parts to the “To Location”inventory as the user selects the “Close Tag”command (also see Tracking Module above).

The Inventory Module 16 and Tracking Module 14 partially interface with each other directly, when users search TESS inventory for part locations by part number, serial number or lot number and use “Inventory Transfer”to request its transfer between work areas. A user receiving the transfer request may either accept or refuse it. If accepted, the Tracking Module 14 immediately generates a Tracking ID and adds the requested item as a pending outgoing shipment for the workstation accepting the request for part transfer. TESS automatically notifies the requester a part transfer request was accepted or refused as the other user enters his response.

The Inventory Module “Shop Issue”function is used in lieu of the Tracking Tag to track inventory parts issued to a work area with no TESS workstation. The manufacturing employee typically has a work order listing what part is needed to complete a task and use the work order to procure the part from storage. The storage area user selects parts from its inventory (FIFO) or by serial and/or lot number from the “First Select Part Number”command in “Shop Parts Issue”. The “Issue Part” command permits the TESS user to enter Work Order/Job Number data used for tracking part issuance and use in tracking reports.

The commands provided by the Inventory Module 16 are:

Inventory Transfer The command Inventory Transfer, when selected opens the inventory Transfer screen. The user then selects a part and requests that it be transfer to their Workstation. This starts the function InventoryTransfer( ) which request the number of parts and puts the request into the Request Table. The Inventory Module is constantly running the timed event “Check for Inventory”, which runs the function InventoryTransferFind( ). This function constantly checks for new Inventory Transfer Requests in the Inventory Request Table. When one is found, it displays a message at the Workstation indicating that an Inventory Request has been made for parts from their inventory. The user either Accept or Rejects the request. If rejected, “No”is put into the Accept/Reject field in the Inventory Request Table and no further action is taken. If the user Accepts the request, then Accept/Reject field is set to “Yes” and a Tracking Tag is built for that Workstation with the part requested. The user then processes the Tracking Tag with their Tracking Module.

List Inventory The command List Inventory, when selected opens the List Inventory screen that displays all parts inventoried by this Workstation from the Inventory Table. The user may print reports on selected parts. This command is also available for parts that are not inventoried.

Edit Inventory The command Edit Inventory, when selected, opens the Edit Inventory screen that displays all parts inventoried by this Workstation from the Inventory Table. The user may edit or add entries. This command is also available for parts that are not inventoried.

Search for Part Serial Lot The command Search for Part Serial Lot, when selected, displays a message box requesting the item to search for. It then opens the Search Results screen and displays the result of the search from the Inventory Table and Inventory Parts Table. The user may select reports from the results.

Shop Parts Issue The command Shop Parts Issue opens the Shop Parts Issue screen. The user selects the part number and enters quantity, Work Order and shop. The inventory for that part number is then debited.

The following functions are provided by the Inventory module 16 to maintain the inventory. Other Modules use these whenever they are needed.

InventoryCredit( ) This functions credits the requested inventory and is used by the Tracking Module when closing a Tracking Tag. It first ensures the Tracking Tag is closed and that the Workstation closing the Tracking tag has inventory. If these are OK, it proceeds with the credit. It first checks to ensure that the part exists in the inventory. If not, the user is asked it he wants to inventory this part. If no, it is still added to the Inventory Table as a non inventoried part and its inventory flag is set to “No”. The next time this part number arrives at that workstation, The next time this part number is encountered, TESS will know it's a non inventoried part and not ask the user if it is to be inventoried. If the user selects to inventory this part, it is also added to the Inventory Table and its inventory flag is set to “Yes”. Next the user is asked for the bin location, and the part is added to the Inventory Parts Table. If the Part exists in the Inventory Table and its inventory flag is set to “Yes”and Multiple Locations (if the part is stored in multiple bin locations) is set to “No”, it is added to the Inventory Parts Table at the same bin location and the stock date set to the system date and time. If the Multiple Locations is set to “Yes”then the user is prompted for the bin location and the above process followed.

InventoryDebit( ) This function debits the requested inventory and is used by the Tracking Module when sending a Tracking Tag. It first ensures the Tracking Tag is not closed and that the Workstation closing the Tracking tag has inventory. Debiting is done by a first in first out (FIFO) method unless the part has a serial or lot number. In this case the individual part is debited.

OrderInv( ) The purpose of this function is to place a part on the order that is tracked by TESS. This function is called by both the InventoryCredit( ) and InventoryDebit( ) functions. Its input is the parts list from the Tracking Tag being sent or closed. It first checks to see if the part is inventoried by the Supplier. If true, it is ignored (this part will be processed by the Supplier Module). It then checks to see if the part is an automatic TESS re-order part. If it is, it then checks to see if the part is at the re-order point. If it is, its placed in the Order Table (maintained by the Order Module), and the part On Order flag is set in the Inventory Table.

SupplierInv( ) The purpose of this function is to maintain the Supplier Inventory Table located outside the companies firewall. This function is called by both the InventoryCredit( ) and InventoryDebit( ) functions. Its input is the parts list from the Tracking Tag being sent or closed. It first checks to see if the part is inventoried by the Supplier. If false, it is ignored (this part will be processed by the Inventory and Tracking Modules). This function then updates the Supplier Inventory Table with the revised quantity or makes a new entry if not in the table.

TESS Plus:As mentioned, the four TESS Basic modules combine with the listed six additional modules to form TESS Plus. Together with TESS Basic modules, the ten TESS Plus modules not only track inventory on hand and its in house transit between TESS work areas and the manufacturer's facilities, they also track order and receipt of inventory from suppliers, track sales and expedites product shipment to its customers, and track whether or not deliveries/shipments are processed and paid as stipulated by contract.

The Inventory Module 16 interfaces directly with the Order Module 18 to track inventory levels and to order or reorder parts as quantity on hand drops below minimum levels.

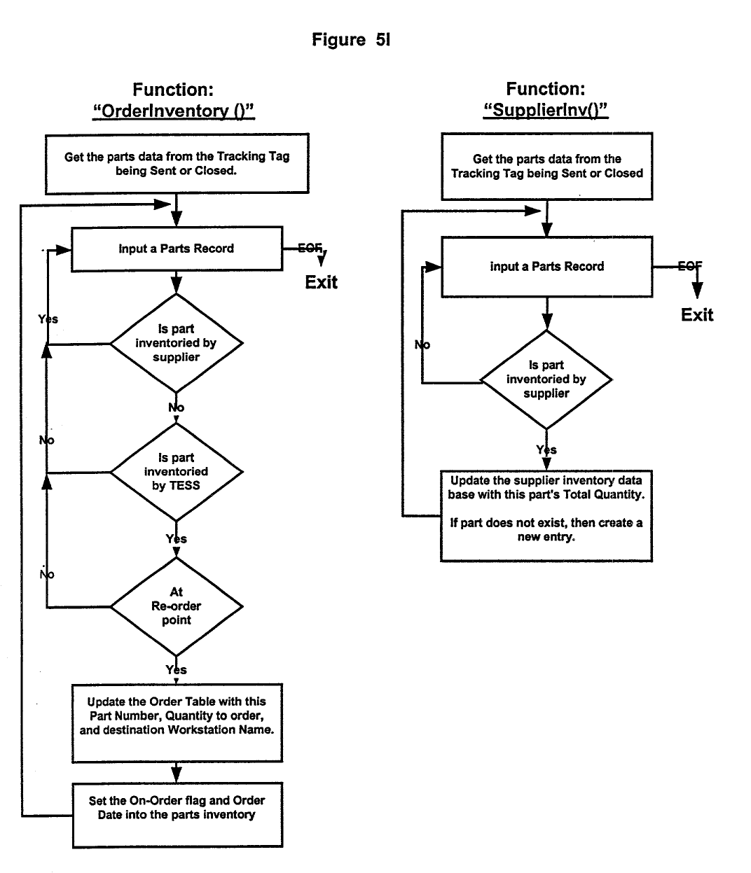

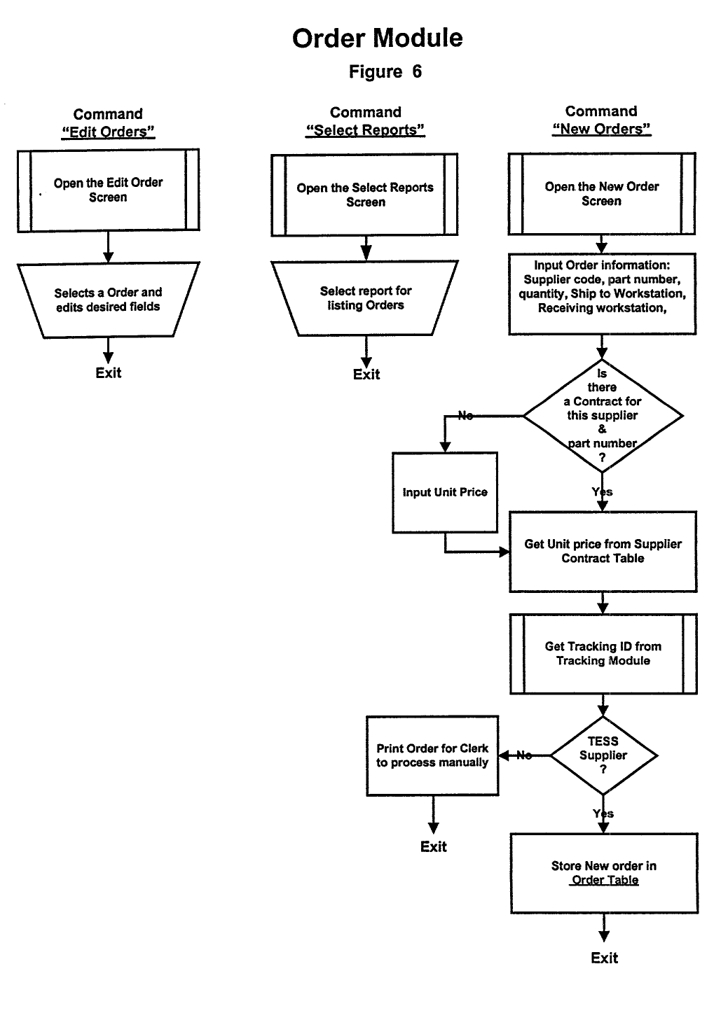

FIG. 6 shows the Order Module flow. The Order Module 18 is used to order parts, to request new parts not previously stocked as inventory, to edit TESS generated orders, and to initiate new orders automatically generated from inventory shortages (safety stock violations). Orders can also be generated upon usage of inventory or inventory adjustments that create the order process in the Inventory Module. Other data entered on the order is information the manufacturer requires of suppliers to track delivery. The Tracking Module 14 assigns the order a Tracking ID as the order part data is entered in the Order Module 18 and prior to printing the order for routing or sending an email to the supplier. Reports tracking inventory orders are also included as part of the Order Module 18.

The commands provided by the Contracts Module 24are:

Edit Orders The command Edit Orders, when selected, displays orders by the requesting address. The user is then permitted to revise selected fields.

Select Reports The command Select Reports, when selected, opens the Report Selection screen. The user can select a custom report from the reports list for any Order.

New Orders The command New Orders, when selected, opens the New Order screen. The user inputs the new order information: Supplier Code, Part Number, Quantity, Ship to Workstation (Receiving Area), and Receiving Workstation (Workstation ordering part). The Supplier Contracts Table is checked to see if a contract exists for the Supplier and part number. If not, then the user must input the Unit Price; otherwise it is obtained from the Supplier Contracts Table. A Tracking ID is then assigned to the Order. If the Supplier is a TESS Supplier (connected via TESS) the Order is placed into the Order Table. If the Supplier is not a TESS supplier, the Order is printer for processing by the user.

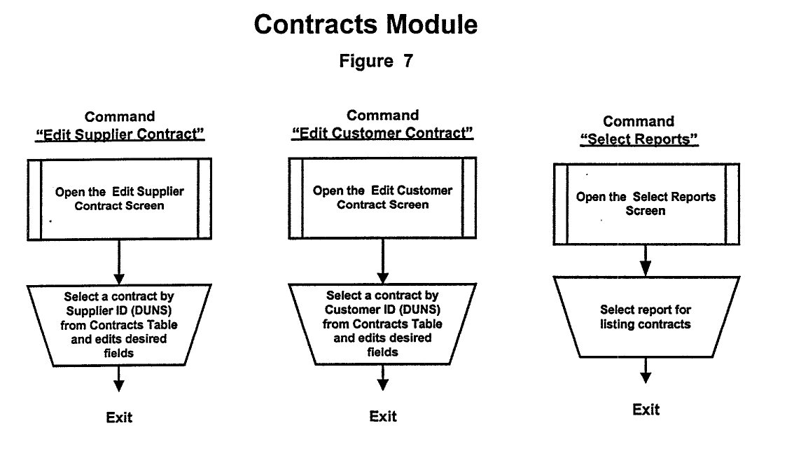

FIG. 7 shows the Contracts Module flow. The Contracts Module 24 is used to manage contract parts, prices, and schedules and to ensure that the Purchase order and contract are in agreement prior to the invoice to the customer. The Contracts Module 24 stores part purchase agreements, terms for purchase, costs, quantities, delivery time frames, etc. in its Contract Tables. It interfaces directly with the Order Module 18 as an inventory order is generated to ensure no discrepancy exists between what is ordered and contracted pricing agreements.

The commands provided by the Contract Module 24 are: Edit Supplier Contract The command Edit Supplier Contract, when selected, displays contracts by the Supplier ID (DUNS) entered. The user is then permitted to revise any desired fields that need to be updated upon agreement between the supplier and the customer.

Edit Customer Contract The command Edit Customer Contract, when selected, displays contracts by the Customer ID (DUNS) entered. The user is then permitted to revise any desired fields that need to be updated upon agreement between the customer and the supplier.

Select Reports The command Select Reports, when selected, opens the Report Selection screen. The user can select a custom report from the reports list for any customer or supplier contract.

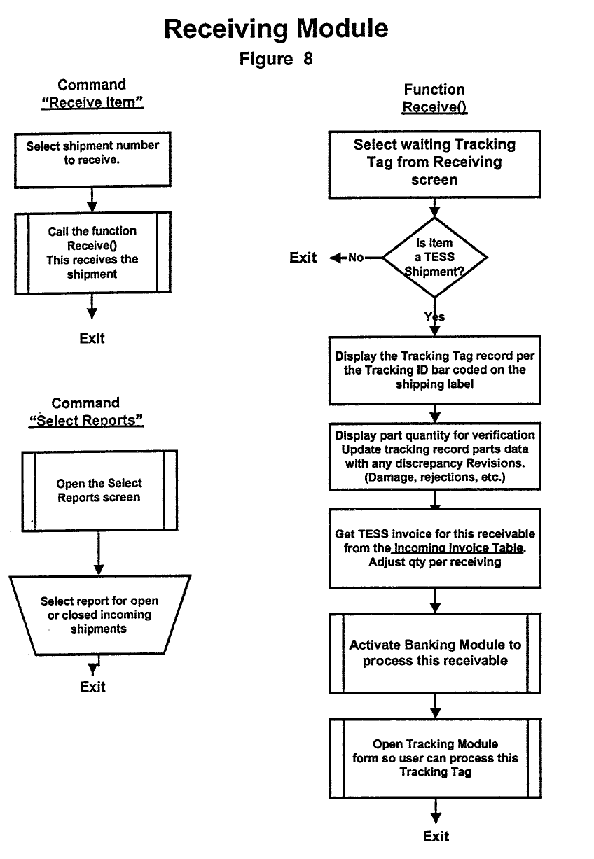

FIG. 8 shows the Receiving Module flow. The Receiving Module 22 is used by workstations designated to receive inventory ordered from suppliers. It is also used to receive the Incoming Invoice (allowing revisions to the quantity) with the shipment, then sending it to the Banking Module 40 for payment. It interfaces simultaneously with both the Order Module 18 and the Tracking Module 14 as an inventory order is entered into TESS. The Tracking ID tag assigned to the order by the Tracking Module 14 and the corresponding part(s) data generated by the Order Module 18 is held pending in the Receiving Module 22 until the ordered part is delivered to the receiving area. Supplier data is input to the receiving module from the delivery label, typically through a remote bar code reader (wand). As delivery data is entered into TESS, part data and the corresponding Tracking ID transfers from the Receiving Module 22 to the Tracking Module 14 as a pending incoming Tracking Tag, and the part delivery is routed as an internal TESS shipment to be credited to inventory at the “To Location.” When the part is received, the Tracking Tag previously received is process in the same manor as in the Tracking Module 14.

As a product is manufactured, a finished item is typically routed as an internal TESS shipment from its work area location to inventory storage (warehouse) and is credited to warehouse inventory.

The commands provided by this Receiving Module 22 are:

Receive Item The command Receive Item, when selected, opens the Receiving Screen and requires (only TESS shipments) user to scan or input the Tracking ID bar code. This displays required fields for verification (receipt quantity) and prompts the user to enter any damage or rejection, if the freight is damaged upon receipt. This action then retrieves the invoice information from the Incoming Invoice Table and then activates Banking Module 40 for payment to the supplier. When complete, The Receiving Module then opens the Tracking Module to process the receipt and have the container and part set to the requesting Workstation.

Select Reports The command Select Reports, when selected, opens the Report Selection screen. The user can select a custom report from the reports list for any incoming shipment.

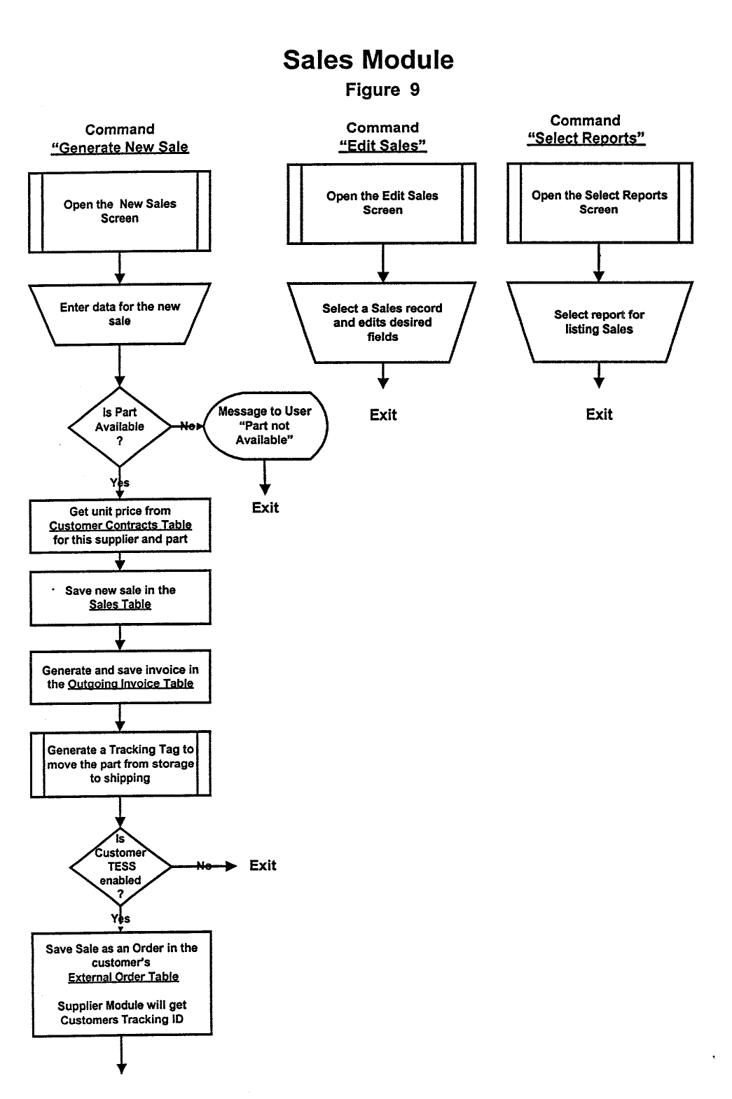

FIG. 9 shows the Sales Module flow. The Sales Module 26 is used to create, edit, and manage sales information for the supplier before shipping a product to a customer. It uses information that has already been input in different tables by other TESS interfacing modules (Contracts, Invoice, and Inventory).

A Sales Module user initiates a sale by opening the “New Sales Screen”and entering sales data. The Sales Module 26 interfaces directly with the Contracts Module 24 to ensure terms of the sale do not conflict with the “Customer Contracts Table”then save sales data in the “Sales Table”. A Sales Module user then interfaces with the Invoice Module ** to select the “Outgoing Invoice Table”to ensure terms of sale also agree with the Contracts Module “Customer Contracts Table.” Fields of an “Outgoing Invoice Table”can be edited when needed. The Sales Module 26 then generates the Internal Tracking Tag and transfers it with the corresponding sale data in TESS to the warehouse workstation Tracking Module 14 as a pending shipment to be routed with the sold part to the Shipping workstation. The sold part is debited from storage inventory, as the warehouse TESS user routes the Internal Tag and corresponding part to a Shipping workstation.

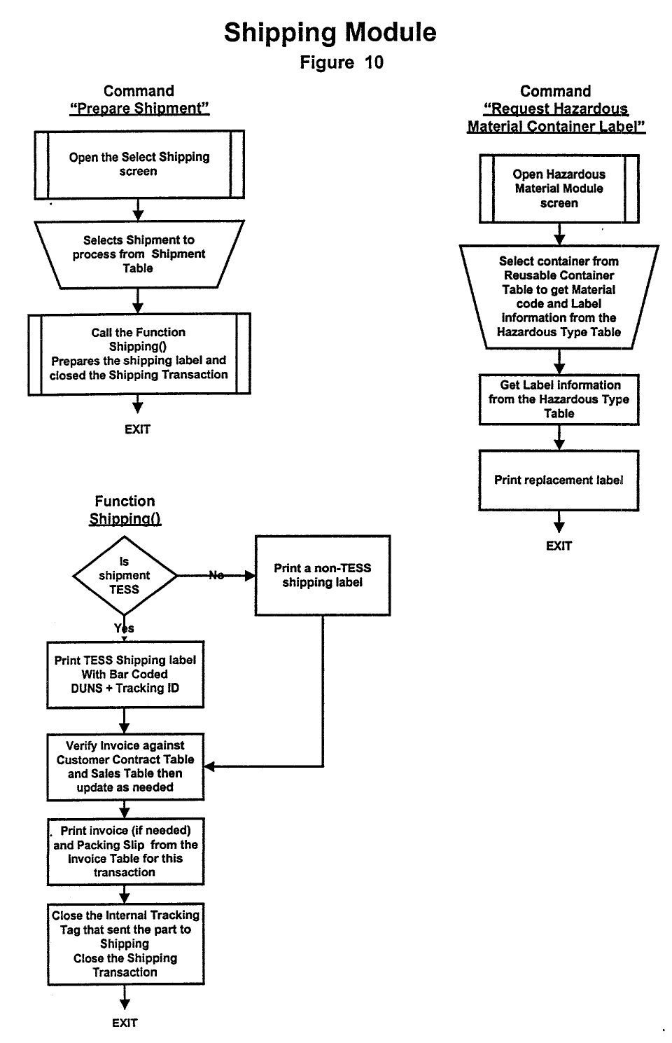

FIG. 10 shows the Shipping Module flow. The Shipping Module 28 is used to ship parts ordered through the Sales Module 26. These orders may be ones generated from the Supplier Module 30 or directly input at the Sales Module 26. This module has no table. It gets its data from the Sales Table, Tracking Table, Hazardous Type Table, Reusable Container Table, Customer Contracts Table and Outgoing Invoice Table.

The commands provided by the Shipping Module 28 are: Prepare Shipment The command Prepare Shipment, when selected, opens the Select Shipping screen. The user selects a shipment to process and then the function Shipping( ) is executed. This function first checks to ensure that the shipment is a TESS to TESS shipment. If not, the Shipping Module will print a non TESS shipping label. This label will not contain any bar coded information, only the from and to address. If the shipment is a TESS to TESS shipment, the TESS shipping label will be printed with the from and to address plus a bar coded receiving ID for the receiving TESS system. The bar code will contain the DUNS number of the shipping company and the Tracking ID assigned by the receiving company. In both cases, the function will verify the information on the invoice with the Customer Contract Table, and Sales Table for that company and part. The Invoice is updated with any changes, then the invoice and packing slip are printed. The function then closes the Tracking Tag that moved the part to the shipping department by setting the date closed to the system date. Shipping should not have inventory, so no inventory credit should be done.

Request Hazardous Material Label The command Request Hazardous Material Label, when selected, opens the Hazardous Material Label Print screen. The user inputs the hazardous material code, and the documentation and/or label are printed.

The commands provided by the Sales Module 26 are:

Generate New Sale The command Generate New Sale, when selected, opens a New Sale screen. The requires sales information (Part Number, Quantity, Serial No. lot No., Purchase Order, etc) is entered. The Sales Module then checks to see if the part is in inventory. If not, an error message is sent to the user and the sale terminated. If it is available, the data is compared with the contracts data for this Customer and part and retrieves the Unit Price. It then saves the sales data in the Sales Table and generates an Invoice. The Invoice is stored in the Outgoing Invoice Table. It completes the New Sale by saving generating a Tracking Tag to move the part form storage to the Shipping Department. If the Customer is TESS enabled, then the Sales Data is stored into the Inventory Request Table to get the Customer's Tracking ID for the Shipping label. The Supplier Module performs this function.

Edit Sales The command Edit Sales, when selected, opens an Edit Sales screen. The user selects a sales record and edits fields that require update (Quantity, price).

Select Reports The command Select Reports, when selected, list all sales that have been generated for that location. It is used to verify and manage sales that have been processed and ones that still need to be satisfied.

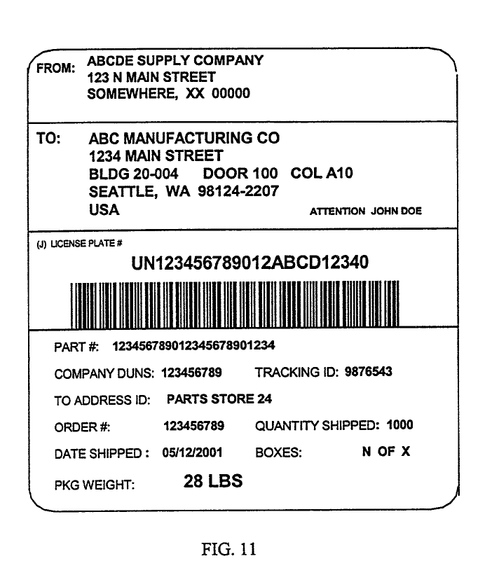

The Tracking Module 14 interfaces with the Shipping Module 28 at TESS Shipping workstations. The Shipping Module user selects the “Prepare Shipment”command to open the “Select Shipping”screen to choose a shipment, and prepare the (outgoing) Shipping Label addressed to a customer with the manufacturer's return address. This label is bar coded with the manufacturers DUNS number and the Supplier's Tracking ID assigned to the order. The user then prints the Sales Invoice to be mailed to the customer and the Packing Slip to enclose with the shipment. The user closes the Internal Tracking Tag to close the shipping transaction and close out the part in TESS Plus. FIG. 11 is an example of an American National Standards Institute MH10 Shipping Label that the Shipping module produces.

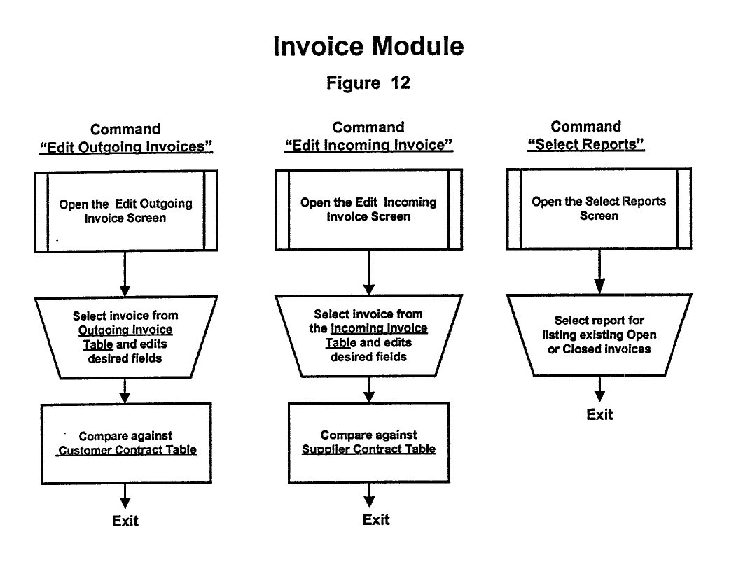

FIG. 12 shows the Invoice Module flow. The Invoice Module 20 is used for editing and printing the Invoice for manual processing. Invoices are created by either the Supplier Module 30 or Sales Module 26. The invoice is sent to the Banking Module 40 or processed manually for payment to the customer. The tables used to store invoice data are The Outgoing Invoice Table and The Incoming Invoice Table. These two tables have the same pertinent invoice data such as Purchase Order Number, Part Number, Price, Quantity, Receipt Date, etc. The Outgoing Invoice Table is used when an invoice is being sent per a receipt for payment and The Incoming Invoice Table is used when an order is sent from the supplier, and is for manual verification if needed.

The commands provided by the Invoice Module 20 are:

Edit Outgoing Invoices The command Edit Outgoing Invoices, when selected, displays all Outgoing Invoices for the company from the Outgoing Invoice Table. The user is then permitted to revise selected desired fields within the Outgoing Invoice Table. If there is an entry for this Supplier and Part Number in the Supplier Contracts Table, it is displayed for the user.

Edit Incoming Invoice The command Edit Incoming Invoices, when selected, displays all incoming invoices for company from the Incoming Invoice Table. The User is then permitted to revise selected desired fields within the Incoming Invoice Table. The if there is an entry for this Supplier and Part Number in the Customer Contracts Table, it is displayed for the user.

Select Reports The command Select Reports, when selected, opens the Report Selection screen. The user can select a custom report from the reports list for any incoming or outgoing invoice.

TESS Supplier:The four TESS Basic modules, and six TESS Plus modules described above, combine with the Supplier Module to form TESS Supplier. TESS Supplier not only tracks inventory on hand and its in house transit between TESS work areas and the manufacturer's facilities, orders and receives inventory from suppliers, expedites sales and shipments to customers, and controls whether or not deliveries/shipments are processed and paid as stipulated by contract, it also adds the Internet interface between the manufacturers Suppliers and Customers who are also TESS Supplier system users.

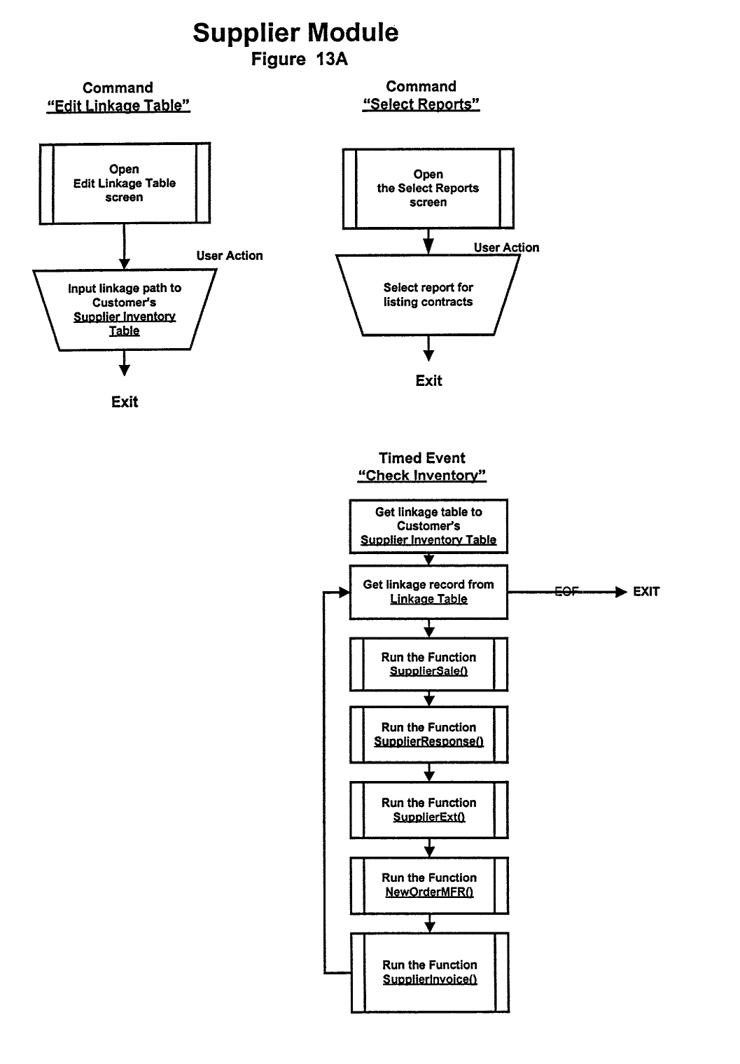

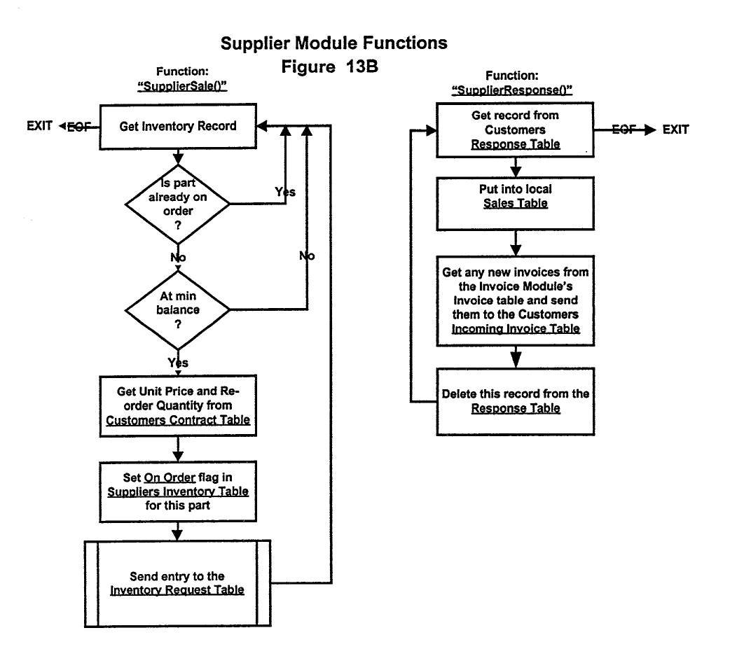

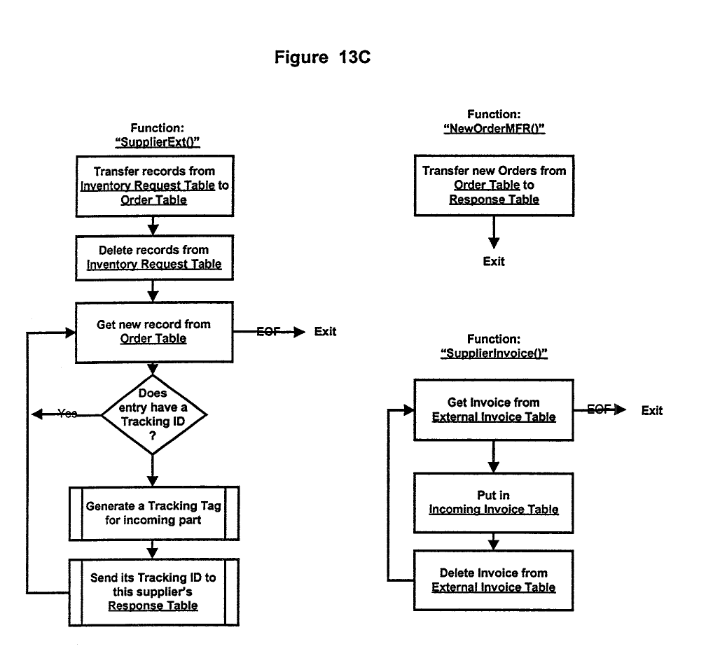

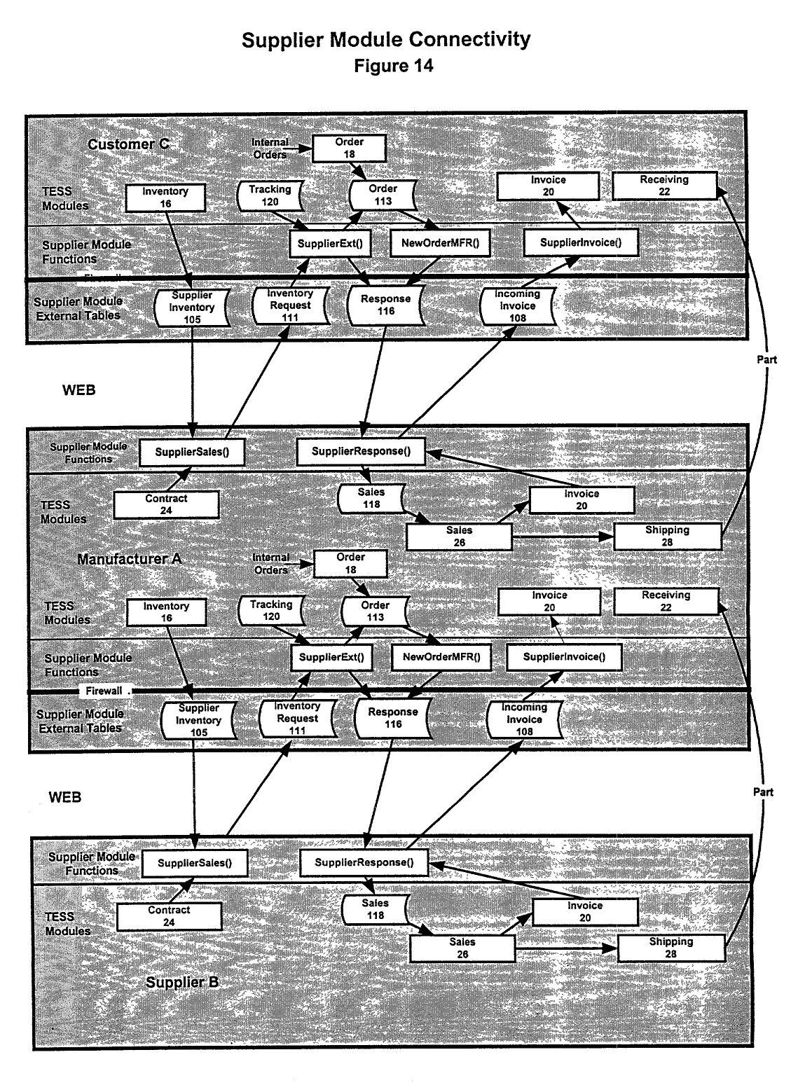

FIG. 13 shows the Supplier Module flow. The Supplier Module 30 is used to interface between the Manufacturers and their Supplier and Manufacturer and their Customers. This interface is shown in FIG. 14, “Supplier Module Connectivity”. The Supplier Module 30 requires that all parties are using TESS. Customers or suppliers not using TESS must interface manually with their legacy systems. The Supplier Module's main purpose is to process orders between companies and to monitor inventories of other companies. The Supplier Module Internet interface permits separate TESS installations to link with each other. Moreover, TESS Supplier enables the manufacturer to delegate responsibility for replenishing its inventory to its TESS suppliers, which also streamlines the ordering and sales process. By making the manufacturer's inventory more visible to suppliers, they are able to anticipate needs of the manufacturer and forecast their own business cycles.

In order to transfer inventory responsibility to its supplier without compromising the manufacturer's security, part or all of the inventory data transferred from the manufacturer to a supplier is placed on a server outside of the manufacturer's firewall. The TESS Supplier module enables the supplier to view inventory that it supplies to the manufacturer, without permitting the supplier access inventory provided by other suppliers. The supplier monitors quantity on hand and when to reorder inventory, while the manufacturer retains debit and credit control. When the supplier's TESS Supplier notifies the manufacturer via the Internet that inventory is low, the manufacturer acknowledges it by transmitting an inventory reorder to the supplier via the Internet interface. The supplier TESS Supplier processes the order as a sale, interfaces it with its Contracts Module 24, sends the invoice via the Internet, and ships the parts using a label that includes the Tracking ID.

TESS Supplier also adds function advantages to other TESS modules. They are:

Inventory reorders generated by the Order Module are transmitted over the Internet eliminating the need for hardcopy orders or E-mailed requests.

Tracking Tag and ID generated by the Tracking Module as the Order Module initiates the order is transmitted to TESS Supplier suppliers over the Internet, which enables the supplier to include the TESS Tracking ID on its part shipment label to the manufacturer.

Invoices are received from TESS Supplier suppliers and sent to TESS Supplier customers via the Internet.

Sales Module functions may interface with its TESS Supplier customers in the same manner as TESS Supplier suppliers interface with its TESS Supplier manufacturers.

TESS Supplier customers Shipping Module labels bear a Tracking ID generated by the TESS Supplier customer.

The commands provided by the Supplier Module are: Edit Linkage Table The command Edit linkage Table, when selected, opens the Edit Linkage Table screen. The user may add, edit or delete linkages.

Select Reports The command Select Reports, when selected, opens the Report Selection screen. The user can select a custom report from the reports list for any Order.

Check Inventory Check Inventory is a timed event function that is executed at a predetermined interval. This interval will be set during installation of this module. Check Inventory connects to Supplier and Customer Servers one at a time and runs the following functions: SupplierSales( ), SupplierResponse( ), SupplierExt( ), NewOrderMFR( ) and SupplierInvoice( ). This function links the Supplier to the Manufacturer or Customer using the DUNS Number as the table linkage.

The first two Functions interface from the Supplier to the Manufacturer, the next three interface from the Manufacturer to the Supplier:

SupplierSale( )—This function checks the Manufacturers inventory in the Supplier Inventory Table setup by the Inventory Module (The Inventory Module is responsible for maintaining current balances). It looks for any parts that are at the reorder level. When one is found, it checks with their Customer Contract Table for Unit Price and verifies the reorder quantity. The On Order flag is set for this part and the order is then sent to the manufacturer's Inventory Request Table. This is repeated until all parts have been checked for all Manufacturers.

SupplierResponse( ) This function checks for responses coming back from the Manufacturer in the Response Table. The response is the Order with a Tracking ID number that is assigned by the Manufacturer to the order just created by the Supplier. The Tracking ID and DUNS number will be bar coded on the Shipping Label and the Manufacturer uses the Tracking ID to receive the part. This function also Stores the Order into the Suppliers Sales Table for processing. When the Invoice is created, this function will store the Invoice into the Manufactures Incoming Invoice Table.

SupplierExt( ) This function checks for orders coming from a supplier in the Inventory Request Table For each Order a Tracking ID is assigned to it in the Tracking Table. The Orders are now placed in the Response Table. The Response Table is also used by the Order Module when generating New Orders manually.

NewOrderMFR( ) This function looks for New Orders created in the Order Table from the Order Module or Inventory Module. These are placed in the Response Table.

SupplierInvoice( ) This function retrieves Invoices from the Incoming Invoice Table and places them into the Manufactures Invoice Table.

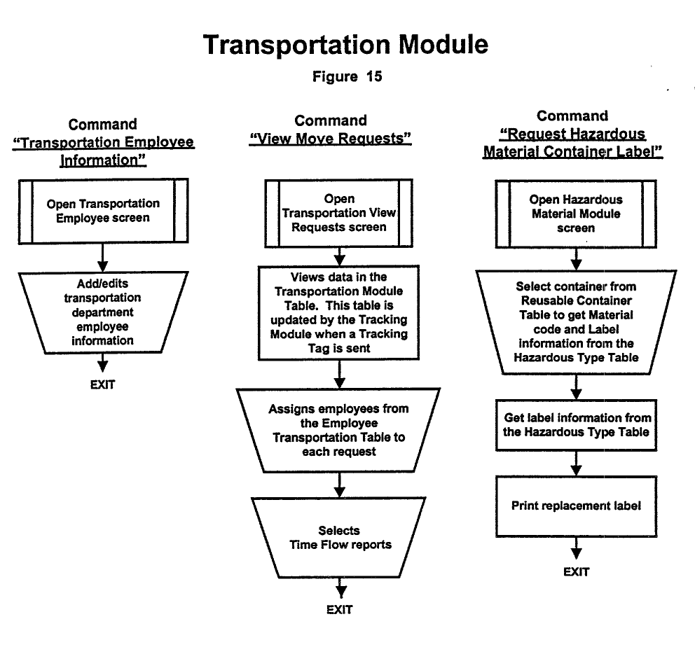

Additional TESS Modules:FIG. 15 shows the Transportation Module flow. Transportation Module 34 is used to track the movement of Tracking Tags within a company. The TESS System Administrator using the System Admininistrator module 10 designates which workstations are designated as a Transportation workstation dispatch area, and only the System Administrator may change the Transportation workstation designation on the Address Table (see System Administrator Module). The Transportation Module 14 is a useful add-on for manufacturing plants structured organizationally with a separate department to transport its internal shipments. This module contains 2 tables. First is the Transportation Table that contains all Tracking Tags being handled by the Transportation department. Second is the Transportation Employee Table, which contains the employees assigned to the Transportation department. It is assumed that employees assigned to a move will use portable Readers and record Intermediate locations.

Outgoing Tracking Tag shipments are added to the Transportation workstation “View Move Requests”command listing as the “New/Edit Outgoing TAGS”user selects the “Send Tag and Print Manifest” command (see Tracking Module). A TESS user at the Transportation workstation selects a person from the Transportation Employee listing to pick up the delivery. TESS users sending a shipment but which do not have the Transportation Module 34 automatically notify the “To Location”by email to pick up their outgoing shipment from the sending location as they select the “Send Tag . . . ”command.

The commands provided by the Transportation Module 34 are:

Transportation Employees Information The command Transportation Employee Information, when selected, opens the Transportation Employee screen. The user is allowed to add, edit or delete employees from the Transportation Employee Table. This table is used to select and assign employees to a transportation job.

View Move Requests The command View Move Requests, when selected, opens Transportation View Requests screen. This screen displays all Tracking Tags from the Transportation Table and allows the user to assign employees to a specific Tracking Tag move.

Request Hazardous Material Label The command Request Hazardous Material Label, when selected, opens the Hazardous Material Label Print screen. The user inputs the hazardous material code, and the documentation and/or label are printed.

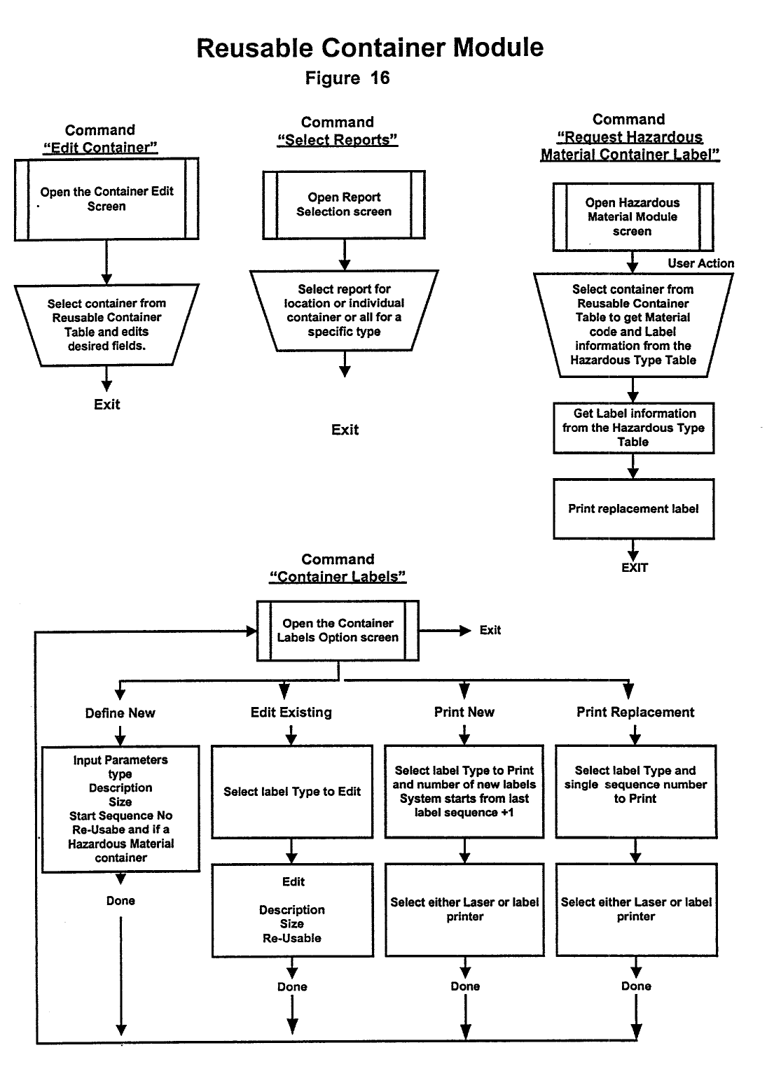

FIG. 16 shows the Reusable Container Module flow. The Reusable Container Module 36 is used to track reusable containers and print container labels for the Tracking Module14. The Reusable Container Module 36 maintains the Reusable Container Table that contains the location of container identified as a reusable container.

Manufacturers, regardless of their size or nature of their business may choose to transport shipments in disposable, one-time use containers and have no need for the Reusable Container module. In practice, most manufacturers ship parts between work areas and facilities in reusable shipping containers. The “Open Container Edit Screen” command enables the TESS user to maintain and update a current list of its reusable containers, including the type, quantity on hand, size, durability, etc. A second command “Open Report Selection Screen” lists container location and availability for sending a shipment. The “Container Labels”command is used to configure container labels with a unique description or number sequence in order to readily identify what “Container Type” to enter as Tracking Tag data.

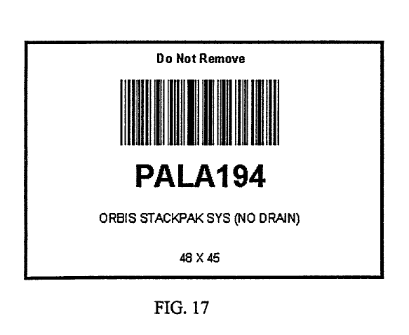

This feature sets up the reusable container table and prints the container labels. This function allows for replacement labels, but duplicates are not normally printed. FIG. 17 is a sample reusable container label. The bar code represents the identifier for tracking the container.

The commands provided by the Reusable Container Module 36 are:

Edit Container The command Edit Container, when selected, opens the Container Edit screen. The user may add, edit or delete entries in the Reusable Container Table.

Select Reports The command Select Reports, when selected, opens the Report Selection screen. The user may select a report to print.

Request Hazardous Material Label The command Request hazardous Material Label, when selected, opens the Hazardous Material Label Print screen. The user inputs the hazardous material code, and the documentation and/or label are printed.

Container Labels The command Container Labels, when selected, opens the Container Option screen. The user may select to define a New Label, Edit Existing labels, Print a New Label, or Print Replacement Labels from the Container Label Table. In this command, the user can define label type as reusable, which adds them to the Reusable Container Table.

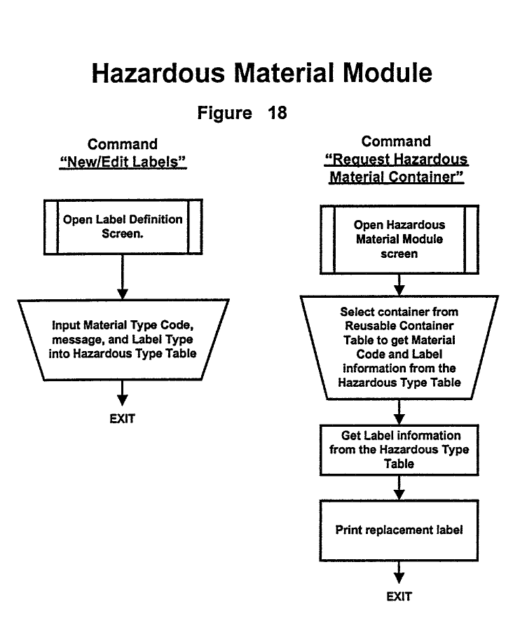

FIG. 18 shows the Hazardous Material Module flow. The Hazardous Material Module is used to print and track Hazardous material labeling and standard documentation requirement by the government. This module maintains the Hazardous Type Table that contains the hazardous material code and it's associated label or documentation requirements.

The Hazardous Material Module 38 interfaces with the Tracking, Reusable Container, Transportation and Shipping Modules 14, 36, 34, and 28 to track and control reusable hazardous material container deliveries. It generates container labels per OSHA standards found on the Hazardous Type Table material code and labeling information, and it provides container handling and storing directions.

The commands provided by the Hazardous Material Module are:

New/Edit Labels The command New/Edit Labels, when selected, opens the Label Definition screen. The user may add, edit or delete entries in the Hazardous Type Table.

Request Hazardous Material Label The command Request Hazardous Material Label, when selected, opens the Hazardous Material Label Print screen. The user inputs the hazardous material code, and the documentation and/or label are printed.

The Banking Module 40 is used to auto credit and debit approved invoices. A separate Banking Module is required for each Supplier, Manufacture, and Customer that is doing business with each other in the TESS electronic environment. This individual requirement supports external and internal suppliers (including all business units within a facility that require separate accounting information). The Banking Module 40 is a link via the Internet from a bank or software support group. All encryptions and other electronic banking standards are supported within the module.

The Banking Module 40 connects trading partners with agreed banking terms for auto debits and credits. It provides instant visibility of account balances, information and transactions. Its interfaces are with the receiving and invoice modules. It enables paperless and automatic electronic banking per contract schedules, following existing electronic banking standards with high-level securities and encryptions.

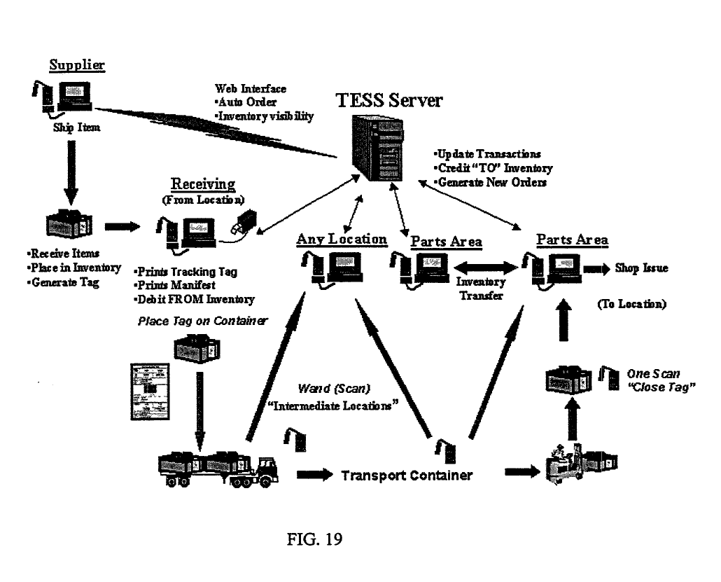

Process Flow:As shown in FIG. 19, TESS is a continuous process and has no defined starting and ending point. Not all functions are included here, but just the primary flow through TESS. As shown for illustration, this process flow begins with the receipt of an order for a new product that was not ordered through the TESS Order Module or Supplier Module and ends with a description of shipping and receiving a TESS-ordered and received item.

Upon receipt of a shipment containing a single part number, a receiving workstation user verifies the quantity and price per the purchase order or contract. Because this is a new order for a new part number, data from the shipping invoice is entered into a new Tracking Tag record. This includes the container identification that the part is shipped in internally, the Address ID (workstation name) of the workstation that ordered the part, the part data which includes part number, purchase order number, serial and/or lot number (if included), quantity, number of boxes, and unit price. A transaction is sent to the Banking module 40 to pay the supplier per the terms of the contract.

Next a Tracking Tag is printed and the item sent to the destination workstation. The transportation department is notified of the move and a person is assigned to the physical move. This person then tracks all intermediate locations that the container stops.

Once the end user receives the item, the Tracking Tag is closed, and its inventory credited.

If the item is new, the user is prompted for the storage location. The user then goes into the Inventory Module 16 and sets up the information required by the Order, Sales or Supplier Module.

Items are issued from inventory by either sending them to another workstation, through sales or through the shop issue function. Sending the parts to another workstation involves generating a Tracking Tag and following the same process as receiving a new part. When the container is sent, the sending workstation's inventory is debited, and when the Tracking Tag is closed the receiving Workstation's inventory is credited.

When parts are issued through sales, the Sales Module 26 generates a Tracking Tag to move the item to the shipping department. When this Tracking Tag is sent, the inventory is debited.

When parts are issued through the Shop Issue function, the inventory is immediately debited. This function then asks the user for the work order for which that item is being issued. This function creates a record with all information about the part including price and purchase order number. This information can be used to track parts back to the supplier through the purchase order number. Typically a work order generates a new part, which is reentered into the workstations inventory when completed. This new part or finished goods is then moved using a Tracking Tag to a distribution warehouse for sales.

Control of the inventory is then passed to the Inventory Module 16 and/or Supplier Module 30 to perform the automatic reordering. At this point the flow through TESS is automated and all further transactions are keyed to the Tracking ID.

Throughout the entire process, multiple reports and lists are available for management or record keeping.

Having described the invention, what is claimed is as follows:

1. An computerized asset inventory and tracking system comprising
a central computer with memory,
a plurality of remote computer workstations in electronic communication with the central computer, at least one workstation located at each of a plurality of parts inventory stations, including shipping and receiving stations,
a plurality of database tables accessible in common by one or more of said workstations,
said tables including
a table of parts inventory in which an inventory of parts is recorded and
a tracking table in which a shipment of parts between parts inventory stations is recorded through said workstations by recording arrival at and departure from said shipment from respective workstations, whereby said shipment of parts is tracked from one inventory station to another inventory station, including temporary shipment stops at workstations intermediate a workstation at an origination parts inventory station and a workstation at a destination parts inventory station,
a plurality of software modules selectively residing in the workstations and operating on the tables whereby said tables are maintained and queried in locating and tracking parts.

2. The system of claim 1 further comprising
a database container parts table wherein contents of a shipping container in which parts may be shipped are recorded.

3. The system of claim 1 wherein one or more of the database tables reside in the memory of the central computer.

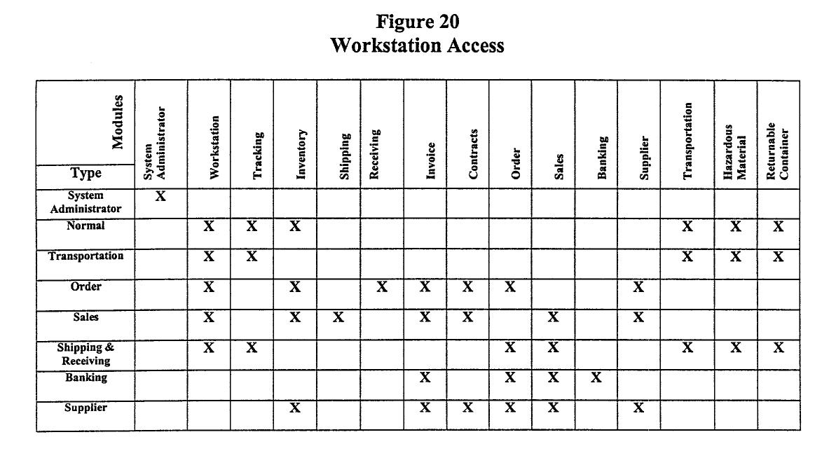

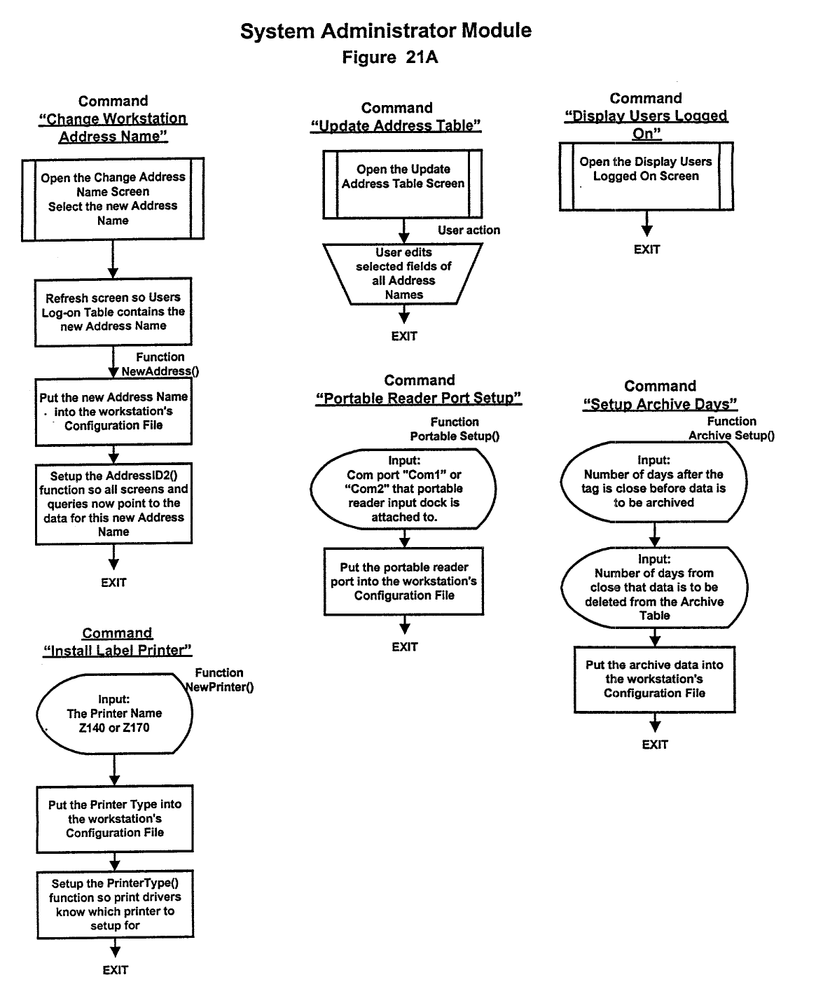

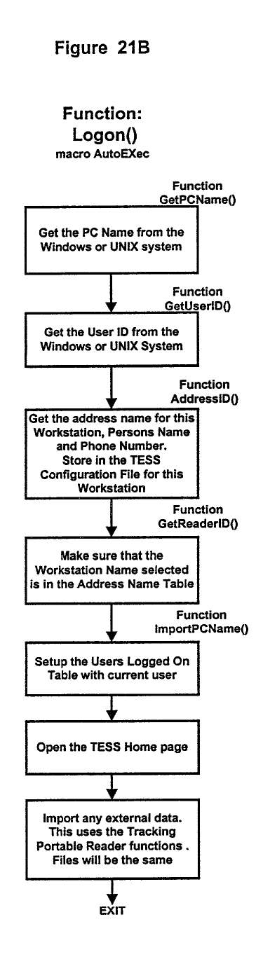

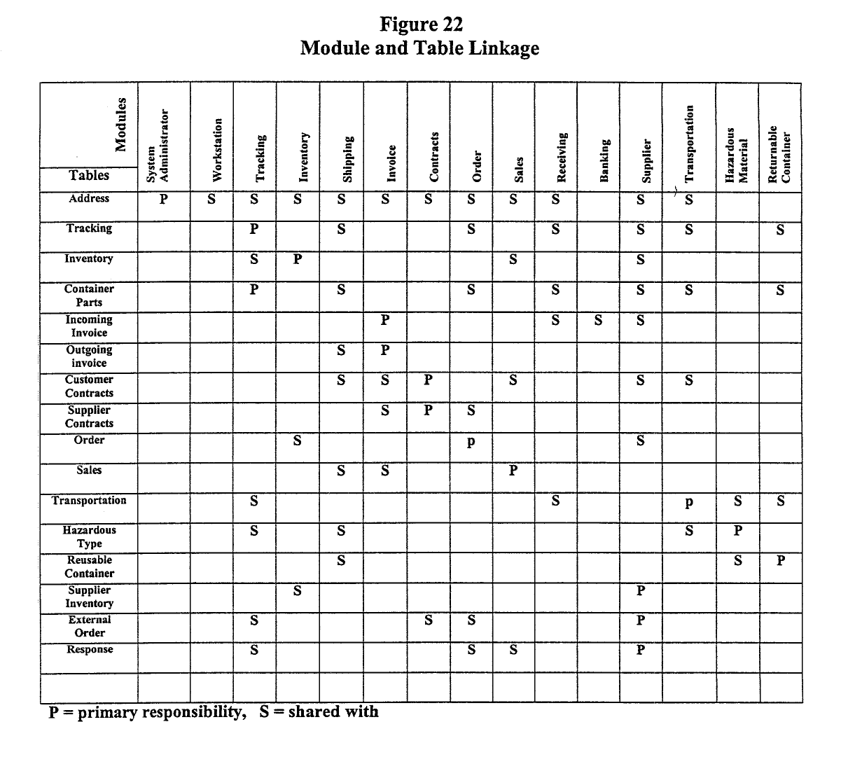

4. The system of claim 1 wherein said workstations include
a system administrator workstation,
a normal, or general, workstation,
a transportation workstation,
an order workstation,
a sales workstation,
a shipping and receiving workstation,
wherein said workstations access selected modules according to FIG. 20.

5. The system of claim 1 wherein said workstations include
a banking workstation,
a supplier workstation,
wherein said workstations access selected modules according to FIG. 20.

6. The system of claim 4 further comprising an software inventory module programmed to record inventory at a workstation address by maintaining an inventory record in an inventory table, said inventory record including inventory part number, quantity, and unit price.

7. The system of claim 6 further comprising a request table and inventory transfer instructions in the inventory module to check for inventory transfer requests in the request table, which table residing on the central computer records transfer requests from other workstations, wherein upon acceptance of a transfer request initiates an inventory transfer.

8. The system of claim 2 including a shipping module and wherein each container is issued a tracking identification code (tracking ID) by the shipping module which tracking ID serves as an identifying code in the several tables to locate and track various parts and shipment containers.

9. The system of claim 8 further comprising
a tracking software module that tracks shipment of containers and parts, said tracking module maintaining said tracking table,
a container parts table and
an intermediate locations table,
said tracking module generating a new tracking ID for a new shipment of a container with parts therein, the tracking ID including a container number, a parts list, and an address of a destination workstation.

10. The system of claim 9 wherein said module is further programmed to maintain an intermediate locations table linked to said tracking ID, a new table entry being recorded in the intermediate locations table for each intermediate workstation location through which said container passes.

11. The system of claim 1 comprising a first asset inventory and tracking system in combination with a similar second asset inventory and tracking system in mutual electronic communication.

12. The combination of claim 11 wherein the two systems are in communication via the Internet.

13. The combination of claim 11
wherein a subset of said tables of said first system is accessible to said second system and a subset of said tables of said second system is accessible to said first system, and wherein tables of said second system record data pertaining to parts transferable upon request for recording by said first system and wherein said second system monitors parts recorded in tables of said first system and initiates an order for replenishment of parts recorded in said first system upon determining satisfaction of a specified order criteria, said initiated order communicated to and recorded in tables of said first system whereupon software modules of said first system query said tables and recognize said order, and wherein upon approval of said order, said first system communicates said approval to a table of said second system, whereupon functions of said second system queries its tables and upon recognizing said approval it its tables, initiates a directive for a physical transfer of said parts from a location recorded by the second system to a location recorded by the first system where upon receipt of said parts, records said parts in tables of said first system.

14. The combination of claim13 where, upon receipt of physical transfer of parts, said receipt is recorded in tables of said first system as located at a receiving workstation.

15. The combination of claim 13 where, upon physical transfer of said parts to a further location, a workstation at that location records receipt of said parts in a tracking table, added in the table to recordings of prior locations therein establishing a history of prior locations receiving said parts.

16. The combination of claim 11 wherein upon said physical transfer being initiated, said second system generates an invoice for communication to said first system concomitant with said transfer.

17. The combination of claim 11 further comprising an invoice software module programmed to generate an invoice from data recorded in an invoice table residing on the central computer.

18. The combination of claim 17 where, upon receipt of said invoice by said first system, payment is generated by accessing a banking table, therein causing automatic payment of the invoice by bank to bank transfer.

19. The combination of claim 11 further comprising a sales software module programmed to check for available inventory, record a parts sale (transfer), and generate an invoice using information recorded in tables residing in the central computer.

20. The combination of claim 11 further comprising a contracts software module programmed to compare a purchase order with a purchase contract and edit required changes, recording edits in various tables residing at the central computer.

21. The combination of claim 11 further comprising an order software module programmed to generate or edit orders for transfer of parts, recording order data in a table residing in the central computer accessible to other software modules.

22. The combination of claim 11 wherein an order for transfer of parts is generated by said first system and recorded it an order table, where after said order table is made available to said second system, and wherein said first system accesses tables of said second system and causes said second system to recognize the new order recorded in its sales table, which causes said second system to initiate transfer of requested parts.

23. The combination of claim 11 further comprising a shipping software module programmed to generate a shipping label including a tracking ID provided by a destination second system and to generate an invoice, the shipping module accessing tables located in the central computer containing required information, including a sales table that records sales made to a given customer, a purchase order number, a part number, parts quantity; a tracking table indexed by said tracking ID that records a container number, a origination workstation address, a destination workstation address, and date; a reusable container table that records locations of reusable containers, a customer contracts table that records customer contract terms; and an outgoing invoice table that records billing terms.

24. The combination of claim 11 further comprising a receiving software module in a receiving workstation programmed to record parts transferred to said first system from said second system, indexed by a tracking identification number (tracking ID) in a ** table, and further comprising a tracking software module programmed to track internal movement of containers and parts, said tracking module maintaining a tracking table, a container parts table and an intermediate locations table, said tracking module generating a new tracking ID for a new shipment of a container with parts therein, the tracking ID including a container number, a parts list, and an address of a destination workstation, said receiving module initiating said tracking module which directs and tracks transfer from said receiving workstation to a destination workstation requesting said parts.

25. The combination of claim 11 wherein selected portions of tables residing in the central computer are copied to tables accessible through the Internet with the remaining tables are protected from access outside of a system.

26. An asset inventory and tracking system comprising a plurality of shared tables residing on a central computer and a plurality of software modules residing on a plurality of computer workstations in electronic communication with the central computer mutually accessing and operating on said tables, said tables comprising
an address table including names and physical locations of workstations,
a tracking table including data included on a tracking tag, comprising an indexing tracking identification number, a container number, a workstation origination address, and a workstation destination address,
an inventory table including inventory data for inventory stored at respective workstations,
a container parts table including part numbers in a container identified in said tracking table,

27. The system of claim 26 wherein said tables further comprise
an order table including orders placed by an entity storing said inventory and orders placed by an entity supplying parts to maintain said inventory,
a sales table including data of sales made to customers,
a customer contracts table including data of purchases of parts from said inventory,
an invoice table including data for billing a sale or order,

28. The system of claim 26 wherein said tables further comprise
a supplier inventory table including data of parts for which a supplier is responsible in maintaining said inventory,
a response table residing on an external server, or central computer, adapted to facilitate transfer of data between a parts supplier and a manufacturer receiving said parts into said inventory,

29. The system of claim 26 wherein said software modules comprise
a tracking module means comprising computer instructions for tracking movement of containers and parts, recording tracking data in tracking, container, and intermediate locations tables,
an inventory module means comprising computer instructions for monitoring parts inventory at a workstation, recording data in inventory tables,
a shipping module means comprising computer instructions for automatically initiating shipment of parts in response to an order, accessing required information in sales, tracking, customer contracts and invoice tables,
a container module means comprising computer instructions for tracking locations of containers, recording data in said container parts table.

30. The system of claim 26 wherein said software modules comprise
an order module means comprising computer instructions for automatically generating orders created from inventory shortages automatically detected in inventory tables,
a sales module means comprising computer instructions for managing supplier sales data using data recorded in various tables by contracts, invoice and inventory modules,
a contracts module means comprising computer instructions for managing parts, prices, schedules consistent with data entered in tables by order and invoice modules.

31. The system of claim 26 wherein said software modules comprise
a supplier module means comprising computer instructions for linking a first computerized inventory system of a supplier and a computerized inventory system of a customer, including
a first, or supplier, plurality of shared inventory and tracking tables and a first, or supplier, plurality of inventory and tracking software modules mutually accessing and operating on said first tables,
a second, or customer, plurality of shared inventory and tracking tables and a second, or customer, plurality of inventory and tracking software modules mutually accessing and operating on said second tables,
an interface module providing a communication interface between said customer tables and software modules and said supplier tables and modules wherein said interface module regularly queries said customer tables and said supplier tables.

32. An asset inventory and tracking system comprising a plurality of shared tables residing on a central computer and a plurality of software modules residing on a plurality of computer workstations in electronic communication with the central computer mutually accessing and operating on said tables, wherein said tables comprise
an address table including names and physical locations of workstations,
a tracking table including data included on a tracking tag, comprising an indexing tracking identification number, a container number, a workstation origination address, and a workstation destination address,
an inventory table including inventory data for inventory stored at respective workstations,
a container parts table including part numbers in a container identified in said tracking table,
an order table including orders placed by an entity storing said inventory and orders placed by an entity supplying parts to maintain said inventory,
a sales table including data of sales made to customers,
a customer contracts table including data of purchases of parts from said inventory,
an invoice table including data for billing a sale or order,
a supplier inventory table including data of parts for which a supplier is responsible in maintaining said inventory,
a response table residing on an external server, or central computer, adapted to facilitate transfer of data between a parts supplier and a manufacturer receiving said parts into said inventory,
and wherein said modules comprise
a tracking module means comprising computer instructions for tracking movement of containers and parts, recording tracking data in tracking, container, and intermediate locations tables,
an inventory module means comprising computer instructions for monitoring parts inventory at a workstation, recording data in inventory tables,
a shipping module means comprising computer instructions for automatically initiating shipment of parts in response to an order, accessing required information in sales, tracking, customer contracts and invoice tables,
a container module means comprising computer instructions for tracking locations of containers, recording data in said container parts table.
an order module means comprising computer instructions for automatically generating orders created from inventory shortages automatically detected in inventory tables,
a sales module means comprising computer instructions for managing supplier sales data using data recorded in various tables by contracts, invoice and inventory modules,
a contracts module means comprising computer instructions for managing parts, prices, schedules consistent with data entered in tables by order and invoice modules.
a supplier module means comprising computer instructions for linking a first computerized inventory system of a supplier and a computerized inventory system of a customer, including
a first, or supplier, plurality of shared inventory and tracking tables and a first, or supplier, plurality of inventory and tracking software modules mutually accessing and operating on said first tables,
a second, or customer, plurality of shared inventory and tracking tables and a second, or customer, plurality of inventory and tracking software modules mutually accessing and operating on said second tables,
an interface module providing a communication interface between said customer tables and software modules and said supplier tables and modules wherein said interface module regularly queries said customer tables and said supplier tables.
wherein said modules access selected tables according to FIG. 20.
an asset inventory and tracking system linking a first computerized inventory system of a supplier and a computerized inventory system of a customer, comprising
a first, or supplier, plurality of shared inventory and tracking tables and a first, or supplier, plurality of inventory and tracking software modules mutually accessing and operating on said first tables,
a second, or customer, plurality of shared inventory and tracking tables and a second, or customer, plurality of inventory and tracking software modules mutually accessing and operating on said second tables,
an interface module providing a communication interface between said customer tables and software modules and said supplier tables and modules wherein said interface module regularly queries said customer tables and said supplier tables.

33. The system of claim32 wherein said interface module checks the customer's inventory recorded in its customer tables whereupon discovering a need for additional inventory according to a predetermined criteria, automatically initiates a parts order to replenish the customer's inventory of that part, recording the order in the a customer's order table and sales table, whereupon receiving approval communication from the customer in a customer response table along with an order-indexing tracking identification number (tracking ID), the interface module initiates a parts shipment to the customer including the customer-assigned tracking ID along with an invoice automatically generated by the supplier according to predetermined terms recorded in a supplier contract table, which order is received by the customer, recording the arrival in a tracking table indexed by the tracking ID and routing the order to a customer destination location where inventory is automatically credited in said customer inventory table.

34. The system of claim 32 wherein said communication interface employs the Internet.

35. An asset inventory and tracking method having a central computer with memory, a plurality of remote computer workstations in electronic communication with the central computer, a plurality of database tables accessible in common by one or more of said workstations, said tables including a table of parts inventory, and a tracking table, comprising the steps of
recording inventory of parts in a database parts inventory table accessible from a portion of said computer workstations,
recording shipment of parts from an origination workstation to a destination workstation in said tracking table,
debiting said parts from inventory of said origination workstation, recorded in said table of parts inventory,
crediting said parts to inventory of said destination workstation,
recording arrival and departure of said shipment of parts at all intermediate workstations through which said shipment passes, if any, in a database intermediate locations table therein tracking shipment of said parts between said origination workstation and said destination workstation by querying said intermediate locations database table.

36. The method of claim 35 further employing a shipping container to transport said parts further comprising the step of recording inventory of parts being shipped in a container parts database table, said table accessible by a plurality of computer workstations to locate and track said parts.

37. The method of claim 35 further comprising the following steps:
transferring a portion of the parts inventory table to a supplier table accessible by a parts supplier monitoring parts inventory levels through an electronic interface module, said parts supplier being delegated responsibility for maintaining desired parts inventory to said parts supplier,
maintaining desired parts inventory levels by receiving communication through a supplier interface,
interrogating said supplier interface for supplier communication,
recording in an order table a supplier order initiated by said parts supplier upon supplier analysis of said supplier table in accordance with predetermined criteria to maintain levels of parts inventory for which the supplier is responsible,
recording approval of said supplier order in said order table,
returning said supplier order to said supplier by means of supplier interface,
receiving parts in accordance with said supplier order into inventory, therein reestablishing parts inventory to said desired parts inventory level.

38. The method of claim 37 further comprising the following steps:
generating a tracking identification number to be employed in shipping and tracking delivery of said parts to an inventory destination.
returning said tracking number along with said supplier order
receiving said parts along with said tracking identification number.

39. The method of claim 37 further comprising the following steps:
receiving a invoice from said supplier along with said parts,
paying said invoice by initiating a bank transfer of funds.

40. An asset inventory and tracking software system adapted for programming and implementation on a central computer with memory and a plurality of remote computer workstations in electronic communication with the central computer, at least one workstation located at each of a plurality of parts inventory stations, including shipping and receiving stations, comprising
a plurality of database tables accessible in common by one or more of said workstations, said tables including
a table of parts inventory in which an inventory of parts is recorded and
a tracking table in which a shipment of parts between parts inventory stations is recorded through said workstations by recording arrival at and departure from said shipment from respective workstations, whereby said shipment of parts is tracked from one inventory station to another inventory station, including temporary shipment stops at workstations intermediate a workstation at an origination parts inventory station and a workstation at a destination parts inventory station,
a plurality of software modules selectively residing in the workstations and operating on the tables whereby said tables are maintained and queried in locating and tracking parts including a tracking module that tracks shipment of parts and containers in which parts may be shipped, said tracking module maintaining said tracking table.

41. The software system of claim 40 further comprising
a request table and
an inventory module including inventory transfer instructions to check for inventory transfer requests in the request table, which request table records transfer requests, wherein upon acceptance of a transfer request initiates an inventory transfer.

42. The software system of claim 40 further comprising
a shipping module that issues a tracking identification code (tracking ID) which tracking ID serves as an identifying code in the several tables to locate and track various parts and shipment containers.

43. The system of claim 42 further comprising
a container parts table and
an intermediate locations table in which is recorded arrival at and departure from a workstation of a shipment container, including intermediate workstation locations through which said container passes.
